(19) United States
(12) Patent Application Publication
(10) Pub. No.: US 2004/0139238 A1
(43) Pub. Date: Jul. 15, 2004

(54) Programmable switching system

(76) Inventor: Peter A. Luhrs, Columbus, OH (US)

Correspondence Address: Michael A. Forhan, Esq., Thompson Hine LLP, Suite 700, 10 W. Broad St., Columbus, OH, 43215-3435, US

(21) Appl. No.: 10/745,249

(22) Filed: Dec. 23, 2003

Related U.S. Application Data
(63) Continuation-in-part of application No. 09/748,925, filed on Dec. 27, 2000.

(51) Int. Cl. G06F 3/00

(52) U.S. Cl. 710/1

(57) ABSTRACT

A programmable electrical switching system. The system is comprised of at least one addressable I/O node, a visual display, at least one button, and a control unit. The control unit is electrically connected to the visual display and the buttons, and responds to actuation of the buttons by transmitting information to the visual display for presentation to the operator and/or transmitting addressed commands to the I/O node. The I/O node controls the voltage and/or current supplied to a load connected to the I/O node in accordance with the commands received from the control portion. Instructions stored in a program portion of the control portion may be changed to change the functions of the electrical switching system. Thus, the buttons may perform a plurality of predetermined, programmable functions in accordance with the instructions.

This application is a continuation-in-part of application Ser. No. 09/748,925, filed Dec. 27, 2000 and incorporated herein by reference.

### FIELD

The present invention is generally related to methods and systems for programming a controller of a multiplexed vehicle network. More specifically, the present invention is related to a method and apparatus for enabling a vehicle electrical designer to design, program, simulate, test and debug the operation of a multiplexed vehicle network controller and associated components. The present invention also relates generally to a programmable switching system and, more particularly, to a programmable electrical switching system for vehicles.

### BACKGROUND

Technological advancements have improved basic vehicle electrical systems during the last few decades. Spurred by availability, user demand, competitive pressures and regulatory requirements, numerous new electronic-based features and components have found their way into vehicles. Such new features include comfort and convenience devices, safety enhancements, entertainment sources, navigation and communication devices, engine and transmission management, on-board diagnostic circuits, and lighting and annunciation systems unique to mission performance, such as emergency vehicle lights and audible alarms.

The number of vehicle features requiring electrical power is expected to continue to increase as vehicles become more and more sophisticated, leaving manufacturers confronted with the problem of how to accommodate the growing complexity and power demand on such vehicles' electrical systems. Recent industry estimates predict that the value of electronics in a typical automobile, which totaled about $940 in 1990, will rise to about $1,720 by 2005. Today, with all of the available options, the wiring within the average passenger vehicle wiring harness totals over a mile in length, weighs in excess of 60 pounds and terminates in over 500 connections. Each vehicle has numerous relays, switches, wiring splices, fuses and other ancillary electrical components. Manufacturing issues related to the electrical system include vehicular weight, spatial limitations, style, packaging considerations and the ability to readily incorporate or delete optional features. These limitations and issues are magnified in special-purpose vehicles such as, for example, police cars, fire trucks, ambulances, school buses, snow removal equipment, street cleaners and tow trucks.

One problem when designing vehicles is effectively controlling ancillary electrical equipment, such as the interior and exterior lighting commonly found on emergency vehicles. The traditional art uses individual electrical wiring connected to a power source and routed throughout the vehicle for each piece of equipment. In addition, separate switches must be provided to control actuation and deactuation of each piece of equipment. The multitude of wiring and switches increases the weight of the vehicle, increases material cost, and increases labor time and expense. Further, the multitude of switches consume scarce instrument panel space and detract from the human factors and ergonomics of the instrument panel. Yet another limitation of current electrical power switching systems is the inherent limitations with regard to reconfigurability. If additional equipment is desired, additional wiring and switches must be strung through the vehicle, a labor-intensive undertaking. There is a need for an electrical switching system that requires less wiring and has a flexible design architecture such that the system is easily reconfigurable.

An additional concern for special-purpose vehicles is the need for proper system integration and information-sharing among the vehicle's sub-systems. Because additional features produce significantly increased demands on a vehicle's limited-capacity electrical system, efficient power management is a growing concern. In addition to efficient power management, a vehicle's design must also take into account system quality, expandability, reliability, maintainability and cost.

In response to these growing concerns, some vehicle manufacturers and after-market component providers have begun to implement more efficient vehicle multiplex systems that can overcome many of the deficiencies of traditional vehicle electrical systems outlined above. Several in-vehicle network protocols are being used: 485 and Control Area Network (“CAN”) based networks comprise the majority, while Local Interconnect Network (“LIN”) allow for adding small, low-cost modules. CAN is already a well accepted standard among European automobile manufacturers, and is becoming a commonly used vehicle network in America and the Far East.

The LIN protocol was jointly developed by Audi, BMW, Daimler-Chrysler, Motorola, Volcano Communications Technologies (“VCT”), Volkswagen and Volvo. The LIN specification covers not only the protocol definition, but also the standardization of tool and application programming interfaces. LIN is a relatively low speed network and transmits between about 1 to 20 kBits per second. Today many vehicles are being manufactured with up to 20 nodes.

V-MUX is a Peer to Peer network protocol developed by Weldon Technologies, that operates between about 1 to 100 kbits per second. V-MUX can operate effectively throughout a vehicle using only a single twisted pair of wires having about 1 twist per inch.

While each of the current network protocols solves some of the deficiencies found in the prior art vehicle electrical systems, use of such networks still results in certain deficiencies, including:

(1) in order to operate properly, each vehicle network requires programming of a controller which must support the configuration of components installed in the vehicle. Presently, the programming of vehicle networks is accomplished utilizing network programming modules that require a user to have specialized technical knowledge and/or be familiar with system programming using ladder logic;

(2) debugging a new vehicle controller program using a conventional network programming module is inefficient and time-consuming;

(3) maintaining vehicle network controller programs written by others is cumbersome and difficult; and

(4) specialized knowledge of each network protocol is required to competently program a vehicle network controller.

A need therefore exists for a vehicle electrical system which addresses the shortcomings of present vehicle electrical systems and networks to more efficiently control and monitor vehicle electrical components. A need further exists for a method and apparatus which enables a user to easily program a vehicle network controller using basic logic without requiring specialized knowledge such as a programming language or knowledge of a particular protocol. Yet another need exists for a method and apparatus for programming a vehicle network which enables the network to provide easily implementable, increased functionality when compared with present methods and systems.

### SUMMARY

One embodiment of the present invention relates to a method for programming at least a portion of a multiplexed vehicle network. The method includes the step of receiving user input via an intuitive graphical user interface. The user input is used to perform the steps of identifying the topological layout of the electrical components in a vehicle network and defining logical relationships between these components. The method further includes the step of compiling network data based on the identified layout and logical relationships of those components. The compiled data is preferably stored for later use or for downloading to a vehicle network node for configuring a multiplexed vehicle network.

A second embodiment of the present invention relates to an apparatus for programming at least a portion of a multiplexed vehicle network. The apparatus includes a means for receiving user input via an intuitive graphical user interface (“GUI”). The apparatus also includes a means for identifying the topological layout of a vehicle network based on user input received via the GUI. The apparatus further includes a means for defining logical relationships between components of the vehicle network based on the user input received via the GUI. The apparatus still further includes a means for compiling network data based on the layout and logical relationships, and a means for storing the compiled data.

A third embodiment of the present invention relates to an apparatus for programming at least a portion of a multiplexed vehicle network comprising a processor and a memory connected to the processor. The memory stores a program to control the operation of the processor, and enables the apparatus to perform the steps of the above described method of the present invention.

A fourth embodiment of the present invention relates to a computer-readable storage medium encoded with processing instructions. The processing instruction can then be used to direct a processor to perform the steps of the above-described method of various embodiments of the present invention.

A fifth embodiment of the present invention relates to a conventional “touch switch” wherein at least one button is made part of the visual display. In this embodiment the user may make selections among various choices shown on a display screen by touching the screen proximate the displayed choices, or touching the screen proximate icons associated with the choices.

One advantage of the present invention is that a vehicle network can be designed and programmed without requiring a user to possess specialized knowledge.

Another advantage of the present invention is that a relatively sophisticated vehicle network can be designed and implemented without requiring excessive electrical wiring.

The present invention also overcomes the limitations of current electrical switching systems by implementation of a programmable switching system. The programmable switching system comprises a I/O node, a visual display, a button and a control unit. The button is associated with the visual display and is in electrical communication with the control unit. When the button is depressed, a corresponding electrical signal is input to the control unit. The control unit is configured to transmit an addressed command signal over a network to a I/O node in response to electrical signals received from the button. The control unit may be pre-programmed to transmit various types of addressed commands corresponding to the intended function for the I/O node and controlled by the I/O node. For example, a command may be a simple ON/OFF command. More complex commands may include (but are not limited to) the ability to send or step through a series of programmed settings such as pulse width modulation (PWM) levels, dimming levels, voltage levels and current levels. Further, time delays may be programmed such that the addressed command is transmitted a desired time after the button is depressed.

An object of the present invention is a programmable switching system comprising at least one I/O node, at least one button, and a visual display. A control portion is in electrical communication with the I/O node, the button and the visual display. The control portion is responsive to a set of predetermined instructions and is adapted to provide information to the visual display for displaying the nomenclature of the I/O node, monitor the button for actuation, control the state of the I/O node in a predetermined manner when the button is actuated, and provide information to the visual display for display of indicia corresponding to the status of the I/O node. The I/O node, the button and the visual display are logically associated with one another by the predetermined instructions, the predetermined instructions being programmable to modify the logical association of at least one of the I/O node, the button, and the visual display.

Another object of the invention is to provide a programmable switching system comprising a plurality of I/O nodes, a plurality of buttons, a visual display, and a control portion in electrical communication with the I/O nodes, the buttons and the visual display. The control portion is responsive to a set of predetermined instructions. The control portion is also adapted to provide information to the visual display for displaying the nomenclatures of the I/O nodes, monitor the buttons for actuation, control the state of at least one I/O node in a predetermined manner when a button is actuated, and provide information to the visual display for display of indicia corresponding to the status of the I/O nodes. The I/O nodes, buttons and visual display are logically associated with one another by the predetermined instructions. The predetermined instructions are programmable to modify the logical association of at least one of the I/O nodes, buttons and visual displays. In addition, the control portion communicates with the I/O nodes by means of a common electrical connection, the I/O nodes being individually addressable by the control portion to control the state of the I/O nodes.

The objects, features and advantages of the present invention are readily apparent from the following description of the preferred embodiments when taken in connection with the accompanying drawings.

### BRIEF DESCRIPTION OF THE DRAWINGS

Further features of the various embodiments of the present invention will become apparent to those skilled in the art to which the embodiments relate from reading the specification and claims with reference to the accompanying drawings, in which:

FIG. 1 is a schematic block diagram illustrating the hardware environment of an embodiment of the present invention;

FIG. 2 is a block diagram illustrating the primary components of an I/O node according to an embodiment of the present invention;

FIG. 3A is a block diagram illustrating an example data protocol according to an embodiment of the present invention;

FIG. 3B is a schematic diagram of the general arrangement of a portion of a vehicle network according to an embodiment of the present invention;

FIG. 4 is an elevational view of a display node according to an embodiment of the present invention;

FIG. 5 is a block diagram illustrating a software architecture according to an embodiment of the present invention;

FIG. 6A is a computer screen display illustrating a VMUX System Designer™ Settings box having a User form according to an embodiment of the present invention;

FIG. 6B is a computer screen display illustrating a VMUX System Designer™ Settings box having an OEM Commands form according to an embodiment of the present invention;

FIG. 6C is a computer screen display illustrating a VMUX System Designer™ Settings box having an Environment form according to an embodiment of the present invention;

FIG. 6D is a computer screen display illustrating a VMUX System Designer™ Settings box having a Vista form according to an embodiment of the present invention;

FIG. 6E is a computer screen display illustrating a VMUX System Designer™ Settings box having an Event Beeps form according to an embodiment of the present invention;

FIG. 7 is a computer screen display illustrating the V-MUX System Designer™ main application window according to an embodiment of the present invention;

FIG. 8 is a computer screen display illustrating the Properties window for an I/O node according to an embodiment of the present invention;

FIG. 9 is a computer screen display illustrating the Properties window for a digital input according to an embodiment of the present invention;

FIG. 10 is a computer screen display illustrating the Properties window for an analog input according to an embodiment of the present invention;

FIG. 11 is a computer screen display illustrating a calibration window for the analog input of FIG. 10 according to an embodiment of the present invention;

FIG. 12 is a computer screen display illustrating the Properties window for an output according to an embodiment of the present invention;

FIG. 13 is a computer screen display illustrating the Relationships window for the output according to an embodiment of the present invention;

FIG. 14 is a computer screen display illustrating the Design window for a system with a Vista node according to an embodiment of the present invention;

FIG. 15 is a computer screen display illustrating the Properties window for screen 1 of Vista display node 6 according to an embodiment of the present invention;

FIG. 16 is a computer screen display illustrating the Properties window for Vista display node 6 according to an embodiment of the present invention;

FIG. 17 is a computer screen display illustrating a Design Tree according to an embodiment of the present invention;

FIG. 18 is a computer screen display illustrating the Properties window for front warning lights according to an embodiment of the present invention;

FIG. 19 is a computer screen display illustrating the Design Tree showing the emergency master button of the EMM screen according to an embodiment of the present invention;

FIG. 20 is a computer screen display illustrating the Properties window for the emergency master button according to an embodiment of the present invention;

FIG. 21 is a computer screen display illustrating the properties window for the emergency master screen-link button according to an embodiment of the present invention;

FIG. 22 is a computer screen display illustrating the Design Tree including a PWM dome lights button according to an embodiment of the present invention;

FIG. 23 is a computer screen display illustrating the Properties window for the dome lights button of FIG. 22;

FIG. 24 is a computer screen display illustrating the Design Tree including 10 levels associated with the PWM dome lights button of FIG. 22;

FIG. 25 is a computer screen display illustrating the Properties window for level 3 of the PWM dome lights button of FIG. 22;

FIG. 26 is a computer screen display illustrating the V-MUX™ Downloader application window according to an embodiment of the present invention;

FIG. 27 is a block diagram of the general arrangement of a programmable switching system according to an embodiment of the present invention; and

FIG. 28 depicts a display node comprising a visual display and a plurality of buttons according to an embodiment of the present invention.

### DETAILED DESCRIPTION

Throughout this specification the term “user” refers generally to original equipment manufacturers, service personnel, equipment installation facilities, repair facilities, modification facilities and so on who possess the requisite skills and training to install, configure and modify the present invention. In contrast, the term “operator” as used in this specification refers generally to vehicle operators and passengers who merely utilize the present invention. In the figures, like parts have been given like reference numerals.

A. Hardware Environment

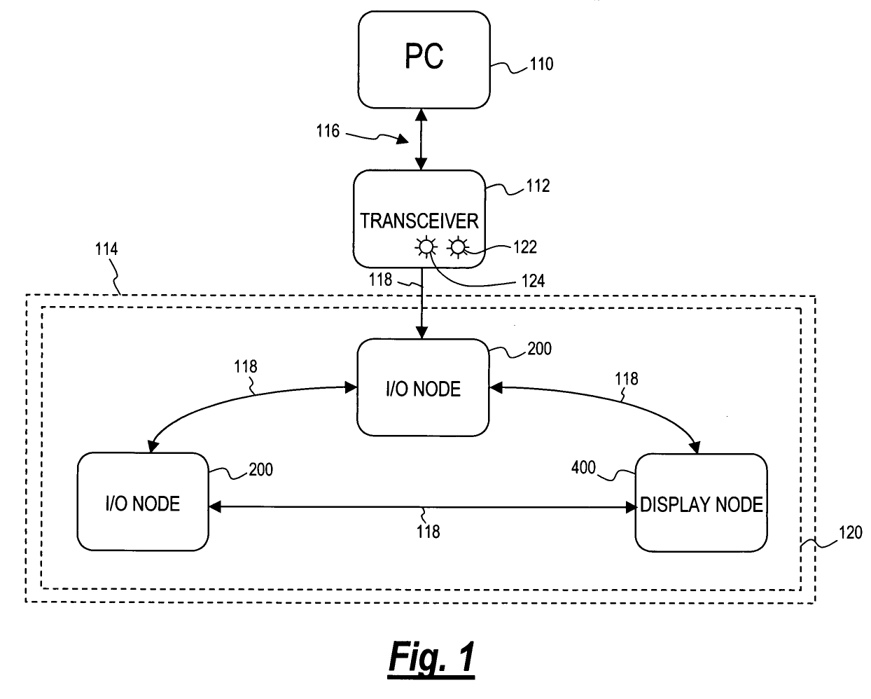

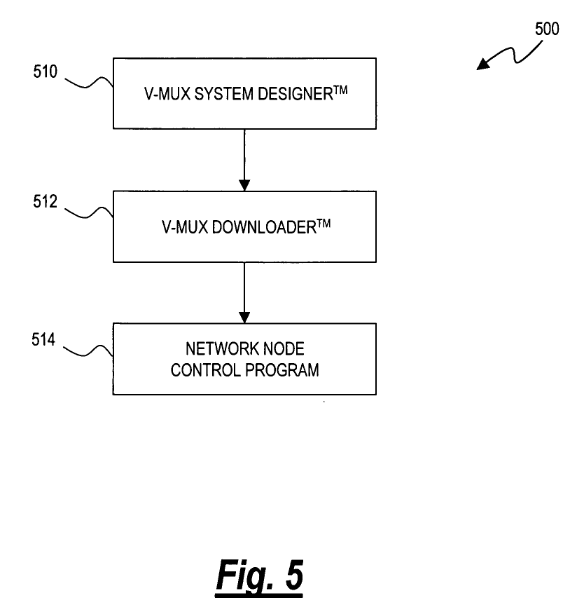

The present invention preferably operates in the hardware environment generally illustrated in FIG. 1. Personal computer (“PC”) 10 is an IBM-compatible computer running a Windows® operating system. PC 110 includes a stored computer program entitled “V-MUX System Designer™” 510 (see FIG. 5), a product of Weldon Technologies, Inc., assignee of the instant application. V-MUX System Designer™ 510 enables a designer to lay out and design the control logic for a vehicle 114 employing a V-MUX® network 120 (hereinafter termed the “vehicle network”), as well as test the operation of a particularly configured vehicle network. PC 110 may also include a stored computer application program entitled “V-MUX® Downloader™” 512 (see FIG. 5), also available from Weldon Technologies, which enables a user to download control logic to various nodes of a vehicle network 120.

It should be noted that although the present invention is described as operating with respect to a vehicle network 120, it is equally well-suited to any conventional vehicle network employing nodes spaced about the vehicle.

With continued reference to FIG. 1, V-MUX Downloader™ 512 facilitates the programming of at least a portion of a vehicle network 120 within a vehicle 114. Network data defining the layout of vehicle network 120 and logical relationships between components of the vehicle network is transmitted from PC 110 to any of one or more I/O nodes 200 of vehicle network 120 via a transceiver 112. Transceiver 112 is a communications device which receives input signals via a conventional data bus interface, such as RS-232, and outputs the received signals via a conventional data bus interface, such as RS-485. A standard RS-232 serial cable 116 can be used to connect PC 110 to transceiver 112, and conventional wiring 118 compatible with RS-485 can be used to connect transceiver 112 to I/O node 200 of vehicle network 120. While the invention is not limited to any particular communications protocol, RS-232 is well suited for transferring data from a PC due to its general use in the computer industry. RS-485 is a preferable protocol for transferring data to and from I/O node 200, in part because the RS-485 standard supports communication lines of greater length than does RS-232. Further, RS-485 allows nodes 200 and 400 to support a single hardware protocol regardless of whether a node is downloading data from PC 110 or communicating with other nodes of vehicle network 120.

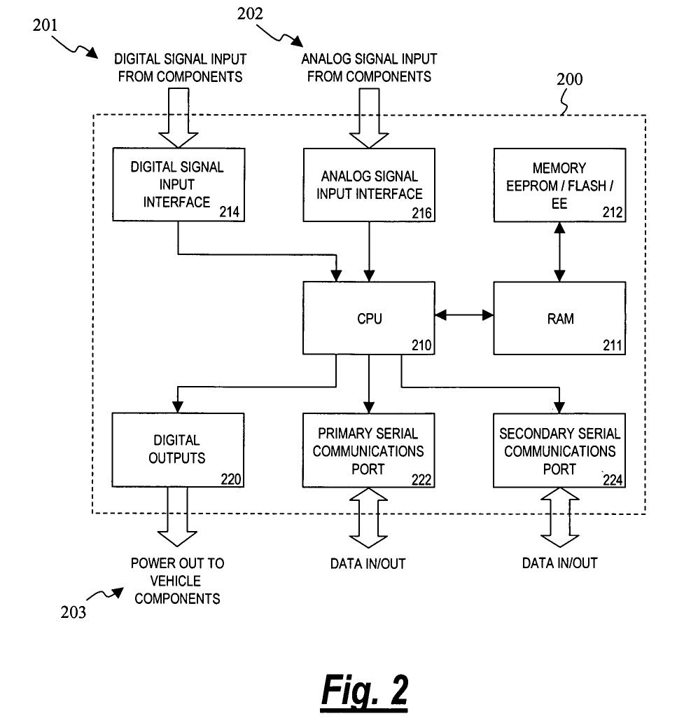

As illustrated in FIG. 1 in combination with FIG. 2, vehicle network 120 is a peer-to-peer nodal hierarchy and may include a plurality of network nodes, such as I/O nodes 200 (also referred to herein as “Hercules”) and a display node 400 (also referred to herein as “Vista”). The nodes 200, 400 are connected together with a conventional data communication wire 118, such as twisted pair, and communicate using the RS-485 protocol, thereby supporting communication at a rate of about 9.6 to 100 Kbaud. The vehicle network performs several tasks, including:

(1) supplying electrical power to vehicle components such as lights or fans via an output 203;

(2) reading the status of digital signals 201 and responding to them by supplying electrical power 203 to vehicle components; and

(3) reading analog data 202 from various types of sensors. This data can be displayed by display node 400 and/or used to turn on vehicle components, such as a warning device, via output 203.

I/O nodes 200 also enable communication with various connected components of vehicle network 120, and is described more fully with reference to FIG. 1. Display node 400 is a Input/Output device that enables an operator to interface with, and control, vehicle network 120. One skilled in the art will realize that the vehicle network 120 of FIG. 1 is merely one configuration of many possible configurations of vehicle networks, and will further appreciate that the present invention will operate with a vehicle network 120 having more or fewer of either I/O node 200 or display node 400. In an alternate embodiment, the present invention may be configured as a vehicle network 120 which does not include any display node 400.

1. I/O Node

Referring now to FIG. 2, the Input/Output capabilities of I/O node 200 are illustrated. I/O node 200 is controlled by a Central Processing Unit (“CPU”) 210 according to a computer control program (not shown) stored in a memory 212, preferably a “flash” memory. The preferred CPU of I/O node 200 is an 8-bit Intel 8051 core. One skilled in the art will realize that other CPU choices and/or memory choices may operate equally well. The control program stored in memory 212 utilizes the network data compiled according to the present invention, and the control program may be pre-loaded or loaded along with the network data transmitted to I/O node 200 in accordance with the present invention.

I/O node 200 comprises one or more digital signal input interfaces 214 to receive one or more digital input signals 201 from vehicle components connected to the node. The digital signal input interfaces 214 are typically connected, for example, to switches or other input devices that provide a digital signal.

I/O node 200 further comprises one or more analog signal input interfaces 216 for receiving analog signals 202 from vehicle components connected to the node. Types of analog signals include, but are not limited to, internal temperature, external temperature, oil pressure, oil temperature and engine RPM. I/O node 200 converts the analog signal to a corresponding digital value compatible with CPU 210.

I/O node 200 further supports one or more digital outputs 220 for supplying data and electrical power 203 to vehicle components connected to the I/O node. Digital outputs 220 are typically used to supply electrical power 203 having a voltage of typically 12 VDC, but in some cases 24, 36, or 42 VDC to power, for example, lamps, gauges, LEDs, displays, floodlights, scene lights, throttle and a high idle control.

I/O node 200 further comprises at least two serial communications ports, primary serial communications port 222 and secondary serial communications port 224. Each of the serial communications ports 222, 224 enable serial data to be sent from and received by I/O node 200. An example of serial data that may be received by communications ports 222, 224 is control commands issued from some point in the vehicle network 120 (see FIG. 1), such as operator input from a control panel, discussed in more detail below. An example of serial data that may be transmitted by communications ports 222, 224 is status and fault data pertaining to I/O node 200 and/or a vehicle component associated with the I/O node. The status and fault data may be shown on display node 400. Depending on the embodiment of the control program of memory 212, I/O node 200 may employ any of a number of communications protocols, such as, for example, V-MUX, CAN, J1708, J1587, J1922 or J1939. Secondary serial communications port 224 may be reserved for diagnosing and/or monitoring engine and/or power train function. Primary and secondary serial communications ports 222, 224 may also be used to control the operation of vehicle components having a serial data communications interface. Further, the communications ports 222, 224 may be used by I/O node 200 to receive status and fault data from vehicle components having a serial data interface.

2. V-MUX Message Protocol

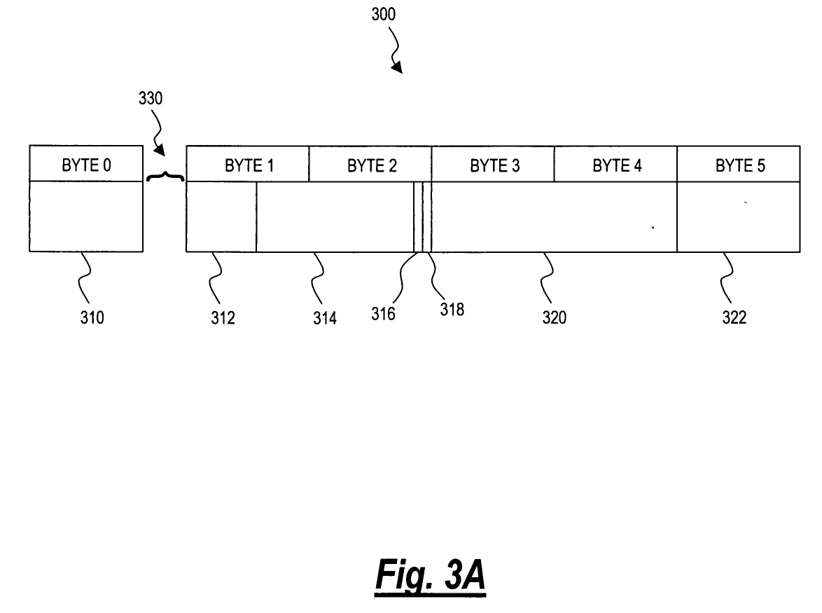

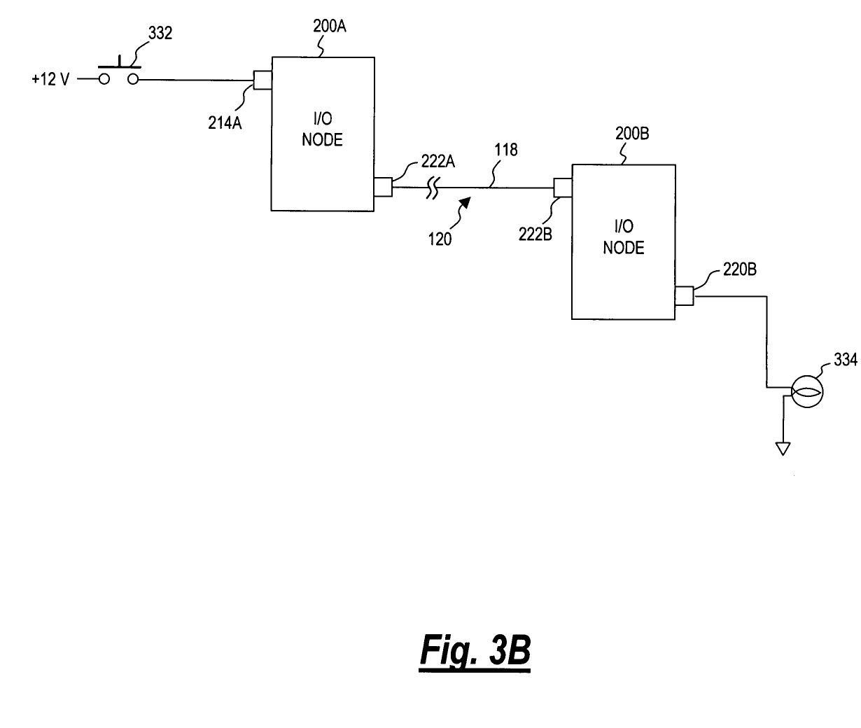

Referring now to FIG. 3A in combination with FIG. 1, there is illustrated a six-byte data protocol 300 according to an embodiment of the present invention. Table 1 sets forth the definition of each data element of the protocol 300.

TABLE 1

| Reference Numeral | Bit Width | Data Element |
|---|---|---|
| 310 | 8 | Tracer Byte |
| 312 | 4 | Start Header |
| 314 | 10 | Command |
| 316 | 1 | On/Off Bit |
| 318 | 1 | Extended Bit |
| 320 | 16 | Data |
| 322 | 8 | Checksum |

As shown in FIG. 3A, protocol 300 begins with an 8-bit tracer byte 310 of zero. When an I/O node 200 is prepared to transmit a message on the vehicle network 120, the node tests the serial (RX) interrupt to determine the status of the bus 118. If bus 118 is not in use, the transmitting I/O node 200 sends out the 8-bit tracer byte 310 as an alert signal to all other nodes that a message is about to be transmitted. If the I/O node 200 and bus 118 support a local echo, the transmitting I/O node 200 may receive the tracer byte 310 and compare it to the tracer byte originally transmitted, to determine that no transmission collisions have occurred. If a collision is detected, the transmitting I/O node 200 will abort the transmission and retry the transmission after waiting for a predetermined period of time.

After sending the tracer byte 310, the transmitting I/O node 200 waits a predetermined period of time in order to provide a phase delay 330. Following phase delay 330, the transmitting I/O node 200 tests the RX interrupt again to determine whether there have been any collisions. As previously described, if a collision is detected, the transmitting I/O node 200 will abort the transmission and retry the transmission after waiting for a period of time.

Following the tracer byte 310, the transmitting node 200 transmits the remaining five bytes comprising message segments 312, 314, 316, 318, 320, 322 of protocol 300. In particular, the transmitting I/O node 200 transmits the 4-bit start header 312, the 10-bit command 314, the on/off bit 316, the extended bit 318, 16-bits of data 320, and an 8-bit checksum 322. Start header 312 is always “1010” and represents the beginning of the message. The 10-bit command 314 represents an action requested by the I/O node 200, or a component connected to the node. For example, as shown in FIG. 3B, the first and second network nodes 200A, 200B, respectively, of an emergency vehicle (not shown) may be configured such that the state of a certain switch 332 activates a set of emergency flashers 334. When the activation state of the switch 332 occurs, first I/O node 200A will receive a binary signal at input 214A and correspondingly transmit at serial communications port 222 a 10-bit command to I/O node 200B via bus 118, the command instructing I/O node 200B to apply electrical power to the emergency flashers 334. Second I/O node 200B receives the command at serial communications port 222B, interprets the command using CPU 210 and the computer program as previously discussed, and activates output 222B to illuminate lamp 334.

Referring again to FIG. 3A, the on/off bit 316 may be used with certain commands to simulate the functionality of a switch. When the on/off bit 316 is a logical “0,” the command is processed as an “off” condition. In a normally-open switch configuration, when the on/off bit is set to “1,” the command is processed as an “on” condition. With respect to the “Emergency Flashers On” command, for example, a status bit set to “1” would cause the emergency flashers to turn on. Likewise, in a normally-closed switch configuration, when the on/off bit 316 is a logical “0,” the command is processed as an “on” condition.

In a preferred embodiment, the extended bit 318 is used to define a three-way switch. An I/O node 200 receiving a command with the extended bit 318 in a set condition will reverse the status of the output associated with the command 314. Of course, in other embodiments the extended bit 318 could be used to enhance the command segment 314, thereby enabling an additional 1024 commands. The extended bit 318 could further be used in conjunction with the data segment 320 to enlarge the range of data values which may be associated with a command 314.

With continued reference to FIG. 3A, if the command 314 has associated data, the data will be transmitted in bytes 3 and 4 of data segment 320. One example of a command which utilizes these data bytes is the “Direct PWM Control” command. This command allows a node to be set to a particular conventional pulse width modulation (“PWM”) percentage. When a Direct PWM Control command is transmitted, the two data bytes contain the node number channel and the PWM percentage to which the channel will be set. For instance, byte 3 of data segment 320 may contain the node number channel while byte 4 contains the PWM percentage value. Data element 322 represents an 8-bit checksum. The checksum may be calculated as the sum of bytes 0-4 modulus 256. After transmitting the entire message, the transmitting node compares the echoed checksum to the calculated checksum to determine whether the transmission was successful. If the compared values do not match, a collision is assumed, and the transmitting node retries the transmission at a later time.

3. Display Node

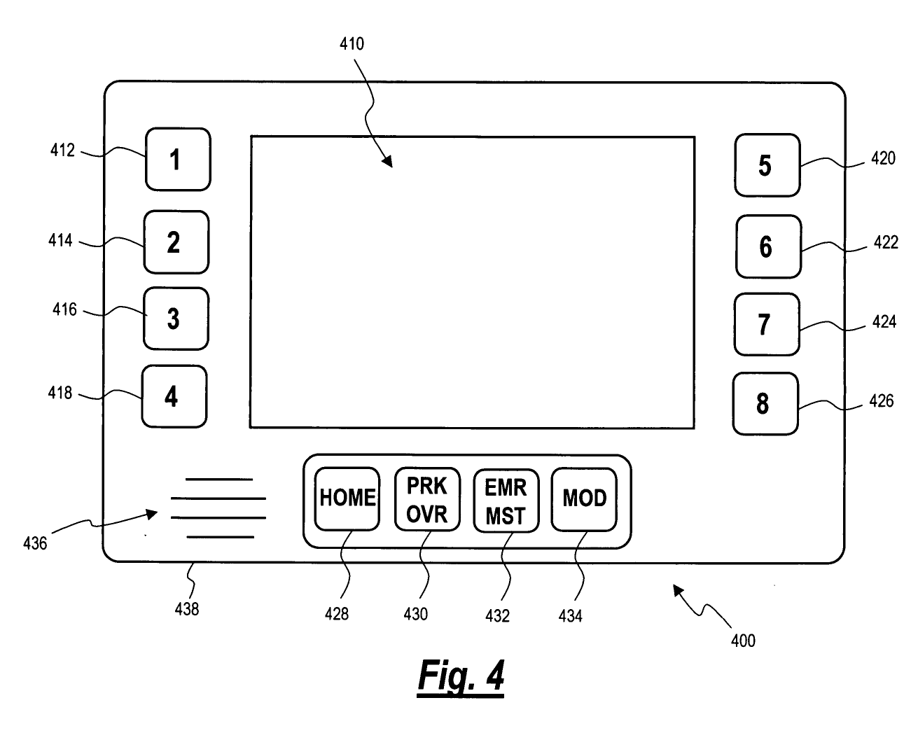

FIG. 4 depicts a front elevational view of a display node 400 according to an embodiment of the present invention. Like I/O node 200 depicted in FIG. 2, display node 400 includes a CPU, flash memory, RAM and serial communications port (not shown). Display node 400, however, differs from I/O node 200 in that it provides an operator interface 412-434 for monitoring and controlling vehicle network 120. The illustrated display node 400 further includes a display 410 for displaying textual data and/or graphics. A portion of display 410 may be reserved for error and other exceptional messages. The messages may be scrolled laterally, if desired. Of course, the present invention is not limited to any particular type, size or configuration of display 410, and one of ordinary skill in the art will appreciate that any of several conventional displays may be well suited for use with the present invention.

Display node 400 further includes programmable buttons 412-434 as part of vehicle network 120. The term “button” as used in this specification refers generally to an electrical switch adapted such that an operator may select and actuate the switch, thus generating an electrical input signal. Example buttons include, but are not limited to, switches coupled to actuator keys or levers, and conventional touch-switches coupled to a visual display.

Button control is determined based on user-defined button properties using a computer program entitled “V-MUX System Designer™” 510 (see FIG. 5), installed into computer 110 (see FIG. 1). Buttons 412-434 may be programmed to turn a networked component “on” or “off,” step through a series of preprogrammed settings (e.g. stepping through light settings in 10% increments, effectively creating a dimmer switch), or change the presentation of display 410. Further, time delays may be programmed for at least a portion of buttons 412-434 to enable a command to be processed a specified time following the actuation of the button by the operator. Further details of the display node and an associated programmable switching system are provided below in the “Programmable Switching System” section.

Buttons 412-426 may be numbered buttons which can be user-programmed for specific tasks depending on options presented on display 410. Buttons 428-434 are programmed to function independently from the content of display 410. The present invention is not limited to any particular type, number or arrangement of buttons, and one skilled in the art will appreciate that a variety of types, numbers and arrangements of buttons may be used. With further reference to FIG. 4, “HOME” button 428 is may be user-programmed to cause display 410 to display a main menu of options. “PRK OVR” or Park Override button 430 may be programmed to cause vehicle network 120 to override a “Park” command which is typically transmitted when the vehicle transmission is placed in “Park.” Properly programmed, button 430 is useful, for example, when a vehicle operator wishes to preserve a particular configuration of lights even after an emergency vehicle has come to a stop at the scene of an accident. “EMR MST” or Emergency Master button 432 is preferably programmed to act as the master emergency light switch. In other words, button 432 enables an operator to turn “on” and “off” an entire set of emergency lights.

“MOD” or Mod Power button 434 is used to meet ambulance requirements to have a separate button for module power. This button may be programmed to turn “off” some or all of the devices powered by the vehicle network 120.

Display node 400 may also include a speaker 436, such as a piezoelectric speaker, mounted behind corresponding openings in the casing 438 of the display node. The grid openings are preferably weather-resistant due to the harsh environments in which special-purpose vehicles, such as emergency vehicles, often operate.

Display node 400 may be programmed using the V-MUX System Designer™ 510 software installed in computer 110 (see FIG. 1) to present several different types of screens on display 410 including, for example, menus, information screens and diagnostic screens. A menu screen enables the operator to use all or some of buttons 412-426 to control aspects of the vehicle network 120 identified on a portion of display 410 generally adjacent to each respective button. An information screen shown on display 410 may present a set of information to the operator, typically in response to input from the operator. Finally, diagnostic screens on display 410 may show diagnostic information to assist a user in localizing a failure of one or more components in the vehicle network 120. Of course, menus and other screens shown on display 410 may comprise two or more nested menus and screens comprising sub-menus and sub-screens.

B. Software Environment

Referring to FIG. 5, there is illustrated the general relationship between software components used by the present invention. Generally, the V-MUX System Designer™ 510 computer program enables a user to define components and commands which may be used with a vehicle network 120, lay out or configure a vehicle network, and define relationships between components of a vehicle network. The V-MUX System Designer™ 510 receives design data from a user via an intuitive graphical user interface (“GUI”), compiles the design data and outputs compiled data which, when interpreted by a control program of a network node 200, 400, determines the functionality of the components of a vehicle network.

The compiled data is used as an input to a V-MUX Downloader™ 512 computer program. V-MUX Downloader™ 512 operates in conjunction with transceiver 112, as previously described with reference to FIG. 1, to program an I/O node 200 to operate according to the vehicle network design provided to the V-MUX System Designer™ 510. V-MUX Downloader™ 512 causes the compiled data to be transmitted to an I/O node 200 of the vehicle network where it is stored in flash memory and referenced by a network node control program 514.

Network node control program 514 is software code that is embedded in a static memory 212 of an I/O node 200 (see FIG. 2), and it controls the operation of the node, in part based on the compiled data. While present invention is directed to the generation of the compiled data, it should be recognized by one skilled in the art that V-MUX System Designer™ 510 could also generate the control program, and that V-MUX Downloader™ 512 could download the control program to a network node in addition to the compiled data.

1. V-MUX System Designer™

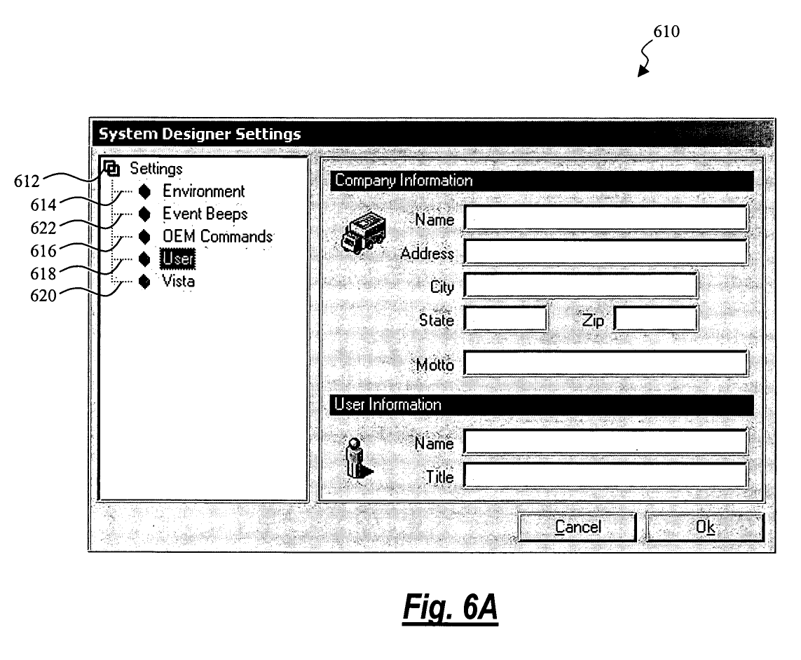

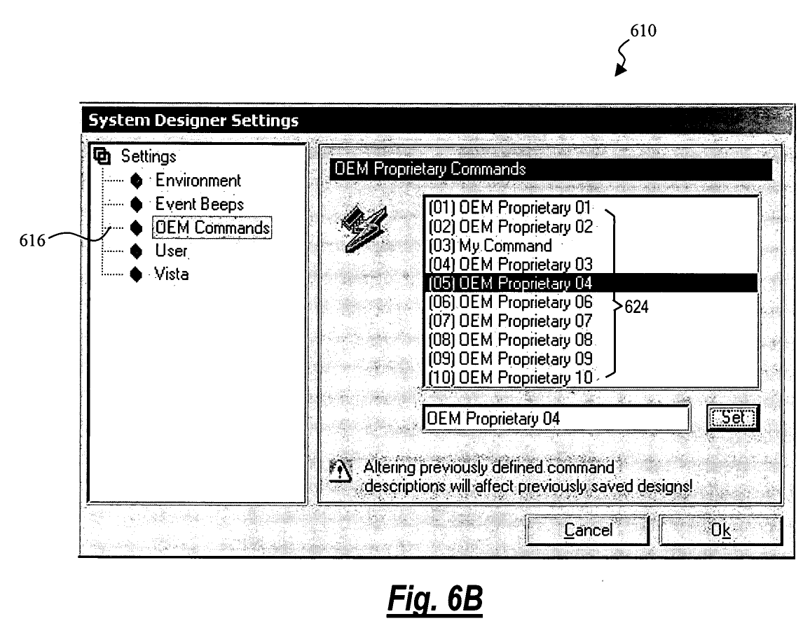

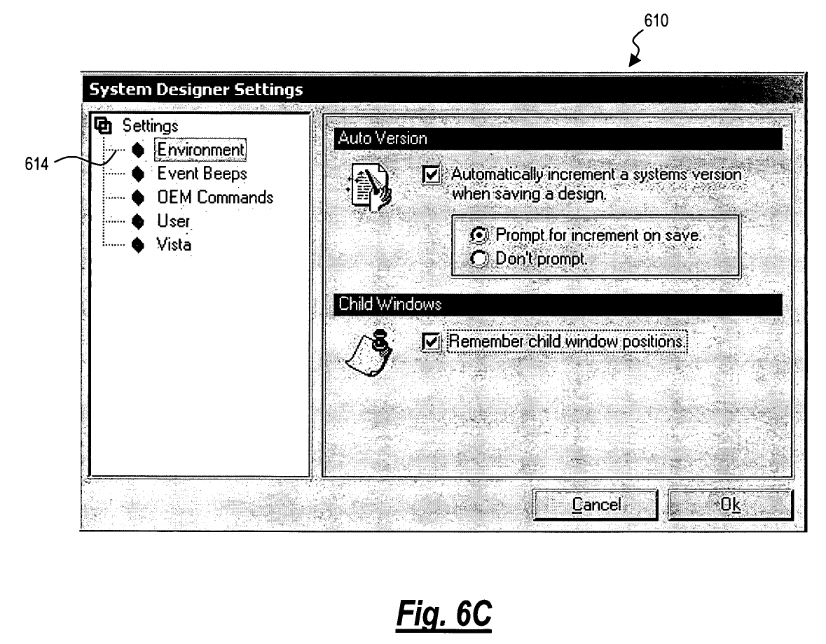

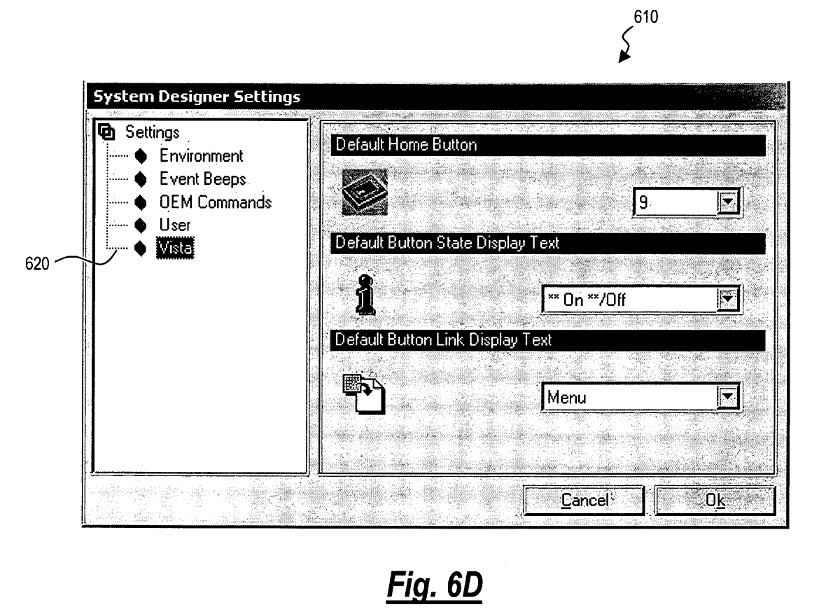

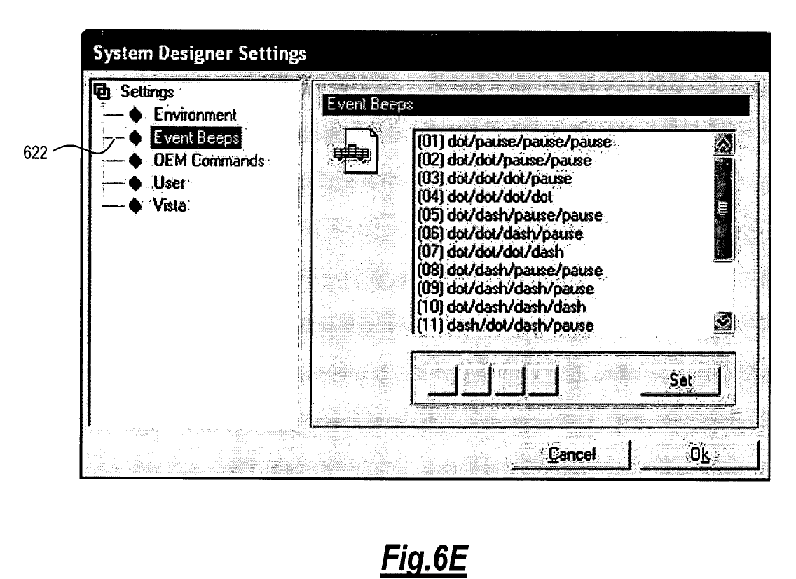

Upon executing the V-MUX System Designer™ 510 in 110 (see FIG. 1) for the first time, the application displays a VMUX System Designer™ Settings screen 610 as shown in FIG. 6A. In a “Settings” tree 612, the user may select “Environment” 614 “OEM Commands” 616, “User” 618, “Vista” 620 and “Event Beeps” 622 to alter settings associated with each respective selection. The default selection is “User” 618 and FIG. 6A shows the “User” settings form. The user may complete this form with appropriate company and user information. This information is used on reports and other areas throughout V-MUX System Designer™ 512.

FIG. 6B shows the “OEM Commands” settings form 616 of VMUX System Designer™ Settings box 610. There are ten customizable OEM commands 624 that can be used to control unique devices for which V-MUX System Designer™ 512 does not have a pre-existing command. The user can provide a unique name for each OEM command 624. Because these settings are retained by V-MUX System Designer™ 512, the OEM commands should be used sparingly. In most cases there will be a command suitable for the user's needs.

FIG. 6C shows the “Environment” settings form 614 of VMUX System Designer™ Settings box 610. The environment settings allow the user to automatically increment the version of the design the user is working on when saving. This means that every time a design is opened and a change is made, a version number associated with the design in the System Properties window will increment by one number. V-MUX System Designer™ 510 also allows the user to select whether a prompt is displayed upon saving. The “remember child window positions” option enables the user to position the VMUX System Designer™ windows in preferred locations for use during subsequent sessions.

FIG. 6D depicts the Vista Form screen 620. The “Default Home Button” option allows a user to select a number from 1-12. The number chosen will be the default setting for the home button on any new designs created by the user. The screen 620 allows a user to select a particular button from a control panel (for example, buttons 412-416, labeled 1-8 respectively in FIG. 4) within a Vista screen to serve as a default “home” button. Vista Form screen 620 also provides drop-down boxes for selection of status text display and link display text. The “Default Button State Display Text” option has a number of selections of such as “On/Off” or “Enable/Disable” to choose from. The “Default Button Link Display Text” has several choices, such as “Menu,” “Link” and “Screen.”

FIG. 6E shows the event beeps form 622. Various sounds may be programmed to be generated upon the occurrence of an event. “Events” may include any predetermined condition, such as the opening of a door. The Events feature allows a user to define different messages and beeps via speaker 436 in the Vista Display (see FIG. 4) or other aural annunciation systems, such as external audio systems. This feature can be used for patient codes in an ambulance, analog warning threshold commands or any other reason desired to warn the driver. By setting the properties for each event, a user can type in a message, select a Beep Pattern, and set how many times the pattern repeats. A plurality of classes and priorities of sounds are available. The highest-four priorities are pre-defined. The lower the priority number the higher the priority, with “1” being the highest priority. A user may use the “Vista Ack.” command from a Vista button to clear events one by one and see other events.

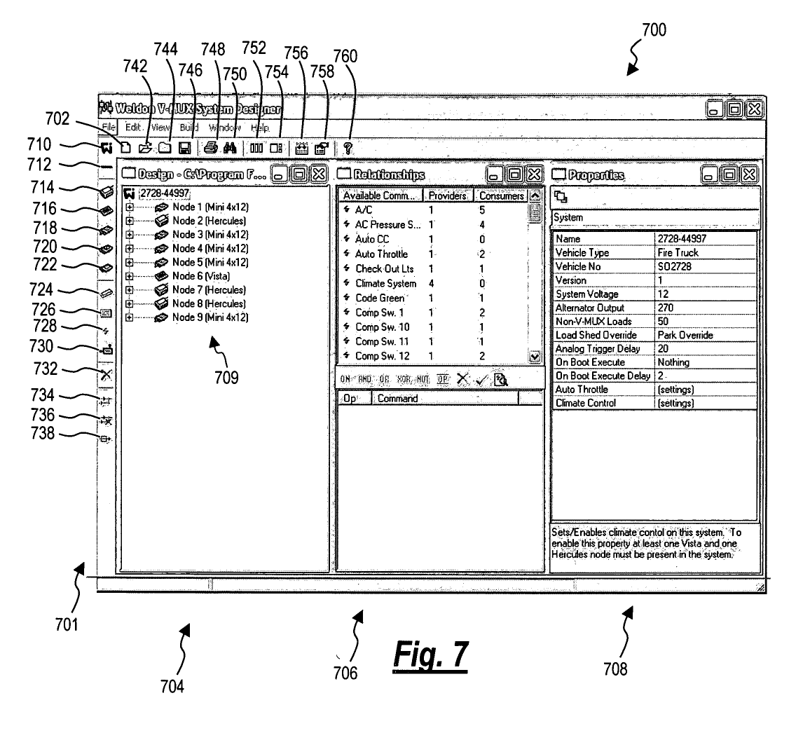

FIG. 7 illustrates the main V-MUX System Designer™ application window 700. By selecting the “Blank Page” icon 702 on the upper left portion of the screen, the user can generate a new system and create three sub-window fields: Design 704, Relationships 706, and Properties 708. These three windows may be used together to create a vehicle application. The Design window 704 shows a Windows Explorer™ style hierarchy of a vehicle network 120. In the Design window 704, a window displaying each I/O node 200 can be expanded to reveal its inputs and outputs.

Properties window 708 displays information relating to a highlighted selection. The user can modify the information by editing the fields of properties window 708. For example, by selecting the “Sample System” at the top of Design tree 709, the Properties window 708 on the right side of the window 700 displays information associated with what is selected in the Design tree. The user can fill out the properties thereby defining portions of the System. Table 2, below, describes each property that may be defined.

TABLE 2

| Property | Property Description |
|---|---|
| Name | This property defines the default name of the design. |
| | The design file name is based on this field. |
| Vehicle Type | This property may have one of a set of values selected |
| | from a drop down list of options. |
| Vehicle No | In some cases, this property may be the same as Name. |
| | Where applicable, a vehicle number |
| | may be stored with the design. |
| Version | This property identifies the revision level |
| | or version of the design. |
| | This number may be automatically incremented |
| | if the user chooses that option in the user settings. |
| System Voltage | This property defines the appropriate voltage for the |
| | vehicle's system. |
| Alternator | This property identifies the total alternator(s) |
| Output | capacity in amps. |
| Non-V-MUX | This property identifies the load value in amps |
| Loads | that will not be multiplexed. |
| Load Shed | This property defines a command that is transmitted |
| Override | over the network to override a load shed command. |
| Analog Trigger | This value, from 0-120, will delay the analog |
| Delay | triggers at startup, for up to 120 seconds. |
| | Delaying the analog triggers will prevent |
| | conditions such as low voltage alarms from triggering |
| | while “cranking” the vehicle's engine starter. |
| | A value of 120 is recommended as the default. |
| | This value may be decreased, if desired. |

Along the left side of the VMUX System Designer™ Main window, there is a tool bar 701 that consists of several icons. The top icon 710 is a blue Weldon logo. Selecting icon 710 docks the tool bar at the top of the screen. Icon 710 acts as a toggle selecting it a second time causes the tool bar to move back. Icon 712 is a mind symbol. It will collapse the node tree from an expanded view. Icons 714-724 provide the user with a selection of various types of I/O and display nodes. Icon 714 represents an I/O node. Selecting icon 714 adds a Hercules I/O node to the Design Tree. Icon 716 is a Vista display Node. Selecting icon 716 causes a Vista Display to be added to the Design Tree. Icons 718 and 720 are selection choices for mini-nodes comprising at least a portion of the features of I/O node 200. Icon 722 is the gateway node. Icon 724 is a Vacuum Fluorescent Display (“VFD”). Selecting icon 724 adds a VFD to the Design Tree. Every Design Tree must have an I/O node selected in order to add a VFD to the Design. Icon 726 allows a screen to be added to a Vista Display. Icon 726 may only be selected while working on a Vista to add Screens. Icon 728 is the command icon. Icon 728 may be used to add a gateway command, add a VFD alarm driver, and add a free command. Icon 730 is used to add a library to the design. Libraries are used for custom features and will lock out some outputs in the design from being used. Icon 732 allows a node to be removed from the Design Tree. Icon 734 is the enslave tool. This tool is used to enslave two or more outputs together. This feature is useful for any device that draws more than 10.5 amps. Icon 736 releases enslaved outputs. To free an output, the output that has been enslaved must be selected, followed by a selection of Icon 736. Icon 738 is used to add a relationship to a selected output. Icon 740 is the compile tool. Selecting icon 740 compiles the data described. Icons 742-760 provide conventional Windows™ control features.

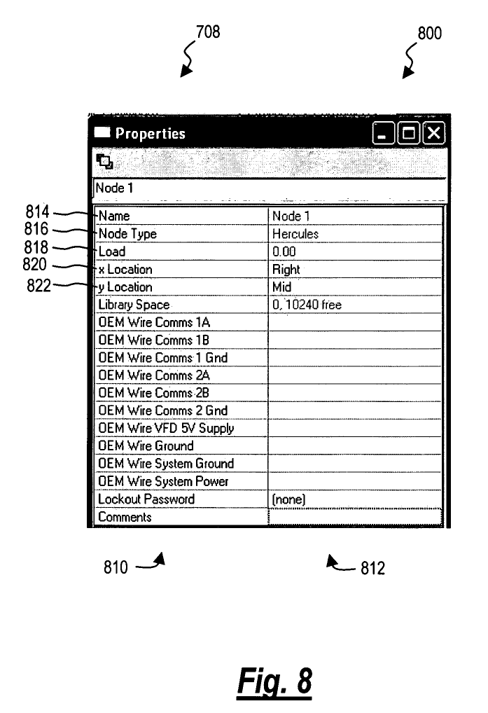

Referring now to FIG. 8 in combination with FIG. 7, there is illustrated an example properties window 800 of window 708, for an I/O node 200. The properties window 800 of FIG. 8 is displayed upon selecting an I/O node 200, such as “Node 1,” in the Design Tree 709. The properties window 800 has two columns. Column 810 contains the nomenclature of the item, while column 812 contains the description of the item. The “Name” property 814 displays the name of the node; the name cannot be changed. The “Node Type” property 816 displays the type of node the user selected when this node was added to the Design tree 709. This property cannot be changed. To change a Node Type the node must be deleted, and a new style node must be added. The “Load” property 818 displays the electrical load in amps that the node has been assigned. The Load is a running total of the output properties of the node. Each I/O node is capable of 110 amps. “X Location” property 820 indicates the location of the node in the vehicle. The selections are Left, Center and Right. The “Y Location” property 822 further indicates the location of the node in the vehicle and may be set to front, mid-front, middle, mid-rear or rear. The X and Y Locations will be used together to determine the general location of the node in the vehicle. This position is utilized by a Node Layout Report (not shown), which produces up to a ‘C’ sized drawing of the design layout.

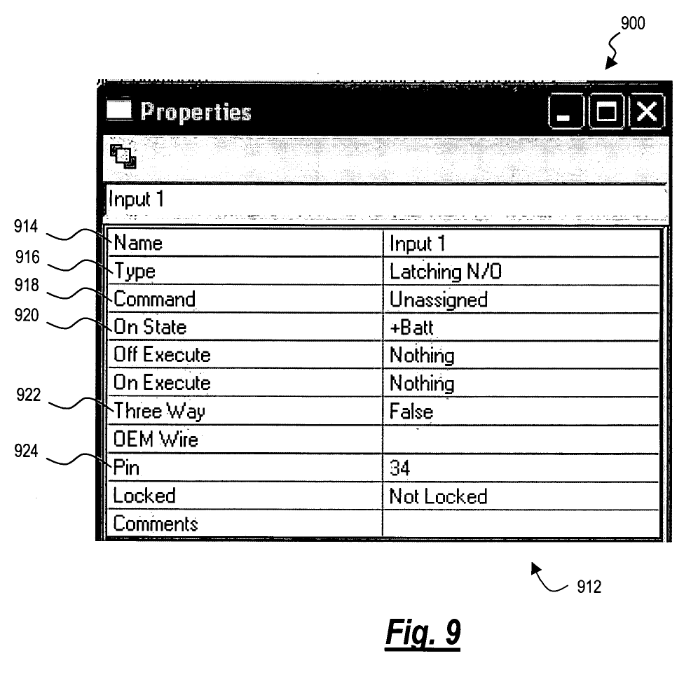

With reference to FIG. 9 in conjunction with FIG. 7, the nodes in the Design Tree 709 have inputs and outputs that can be revealed by clicking on the plus sign to the left of each node. For example, clicking on the plus sign to the left of the input icon reveals the inputs (not shown). One example input may be a door rear switch. If the user selects that input, the Properties window 708 will change to reveal the properties 900 for the input, as shown in FIG. 9. The “Name” property 914 can be set to whatever the user feels is appropriate for naming the input. The “Type” property 916 allows the user to indicate whether a switch is momentary or latching. See Table 3 below for a detailed explanation of momentary vs. latching. The “Command” property 918 allows the user to assign a command to an input from the command database. By clicking on the right hand column 912, a button will appear enabling access to the Command Database. Any command chosen from the command database becomes the default Name of the input. As previously discussed, the name can be changed, but it is recommended that the default name be kept. The command assigned to the name property may be used in Diagnostic Utility for troubleshooting. The “On State” property 920 displays the condition that will change the switch status. In this example, 12 VDC or ground. The “Three Way” property 922 may be set to “True” to control a device from more than one location with the same command. The “Pin” property 924 is the pin number that this channel resides at in the V-MUX connector (not shown).

TABLE 3

| Vehicle Device | Type Property | Reason |
|---|---|---|
| OEM Horn Ring | Latching | The horn should only stay on when holding the |
| | | switch down. Defining this as a momentary input, |
| | | the horn would stay on when pressed once. |
| Rocker Switch - Momentary | Momentary | Assigning this switch as momentary tells V-MUX to |
| Type | | latch the output ON even though the switch does not |
| | | latch closed. |
| Compartment door switch | Latching | A door switch is a latching switch, whether it is |
| | | magnetic or spring loaded. |
| Problem | Cause | Reason |
| Output connected to a latched | Type Property | The Momentary property is assigned to a latched |
| switch turns on if the switch is | is Momentary | switch |
| turned on then off | | |
| Output connected to a physical | Type Property | A Latched property has been assigned to a |
| momentary switch - Goes on then | is Latched | Momentary switch. |
| off when the switch is released. | | |

2. Input Overview

In both the Design Tree 704 and the Relationship window 706 (see FIG. 7), each analog input will include a sine wave icon and a digital input will include a square wave icon. A digital input is used to detect the status of a switch and is either a logical zero or a logical one. There are three types of digital inputs: bi-directional, +V and ground. A bi-directional input can be switched by either +V or ground. +V can only be switched by a +Battery voltage input. A ground input can only be switched by a ground source. Analog inputs are used to read variable voltage from devices such as a pressure transducer or temperature sensor. The analog inputs of an I/O node may be limited to a range of 0-5 volts. It is desirable to define all of the system inputs for each node in the vehicle before assigning relationships to the outputs.

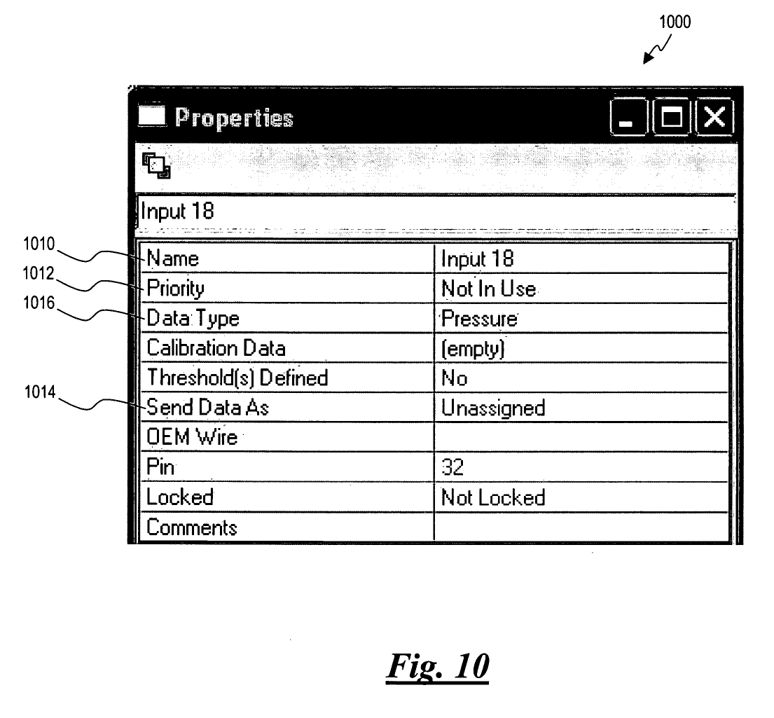

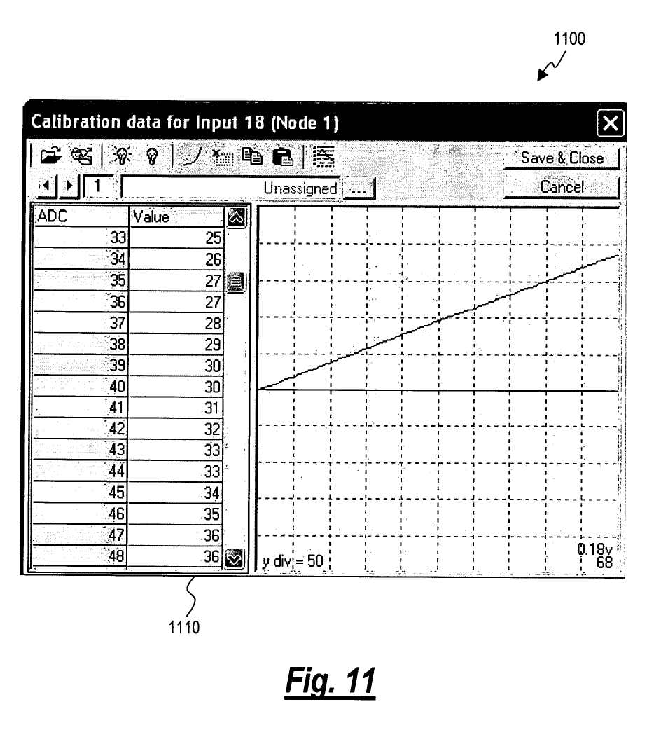

Certain channels of I/O node 200 can be used to read analog devices such as pressure sensors, temperature sensors, RPM voltage devices and other miscellaneous devices and transducers. The device must produce a voltage within a predetermined range, such as 0-5 volts DC. The first step for setting up an analog device is to fill out the Properties screen 1000 (see FIG. 10) after selecting a desired input. The name of the property 1010 is first entered, then the priority 1012. The priority may range from “Not used” to “Very high.” In most cases a low to medium priority is assigned, which will configure I/O node 200 to send the data across the communications bus 118 about every 0.25-0.75 seconds. A high priority setting is preferably reserved for real-time response devices such as a joystick. If the “Not Used” setting is assigned, data will never be sent out by the I/O node 200. It is desirable to assign as low a priority as is practical, in order to keep the data traffic to a minimum on the bus 118. The “Send Data As” property 1014 provides a list of devices that can be assigned. These are analog identifiers and will show up on the diagnostics tools screen, as well as other screens. The “Data Type” Property 1016 allows a user to produce a calibration table and curve for the analog signal. After clicking on “Data Type” 1016, a user will be provided with a pop-up screen 1100 (see FIG. 11). Calibration data is then entered at screen 1110 for the particular device selected by the user.

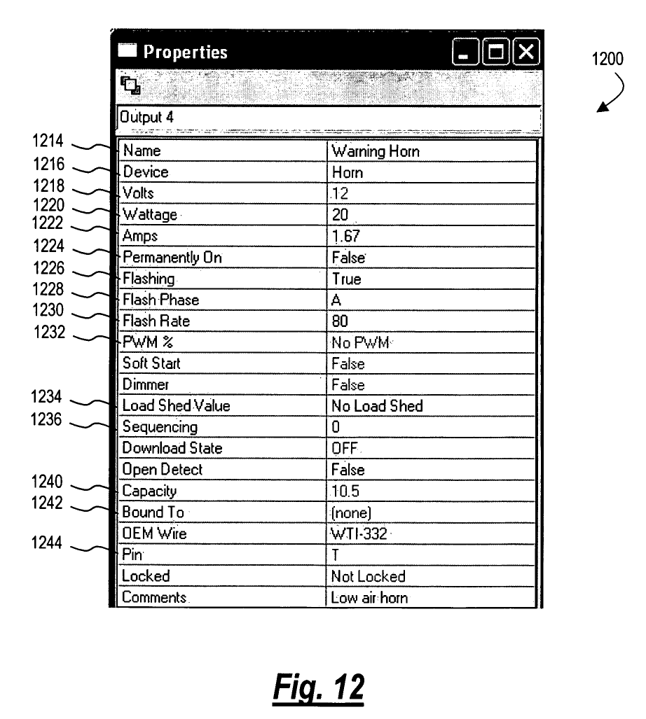

Referring now to FIG. 12 in combination with FIG. 7, there is illustrated a Properties window 1200 of window 708, for an output selected in the Design window 704. The properties of an output are similar to the properties for other devices. The “Name” property field 1214 enables a descriptive tag to be associated with the output device. The “Device” property 1216 identifies the type of output device and is defined and based on types listed in a drop-down box list. The “Volts” property 1218 reflects the voltage assigned to the Device and is fixed according to the System Properties. The “Wattage” property 1220 reflects the device load in watts. The “Amps” property 1222 represents the amperage load of the device. Entering a number in Wattage or Amps, will automatically calculate the other. The “Permanently On” property 1224 enables the user to have an output turned on whenever the system is powered, by setting this property to “True.” The “Flashing” property 1226 may be set to true to flash or rapid-fire the output. The “Flash Phase” property 1228 may be set to A or B depending on the desired flash phase. The “Flash Rate” property 1230 sets the speed of any I/O node to flash. The “PWM” property 1232 sets the pulse width modulation duty cycle for the output. This is only available on physical outputs 1, 2, 15 and 16. The “Load Shed Value” property 1234 sets a load shed value. The user can assign a value of 1-8 on any output, taking into account that lower values such as 1 will be shed first if a predetermined threshold or overload condition is detected, while higher values such as 8 will be shed last. The “Sequencing” property 1236 may be used to assign a sequencing level to an output that draws several amps. Values of 1-4 may be assigned to any output such that a corresponding 1-4 second delay is implemented for turning on or off an output. The “Diagnostics” property 1238 may be set to true or false. It should be set to false if the output is driving a relay or device that is drawing less than 0.75 amp. The “Capacity” property 1240 defines the capability of this channel in amps and should not be exceeded. The “Bound To” property 1242 reflects the user's design decision to enslave two or more outputs together. Finally, the “Pin” property 1244 identifies the connector pin for this output.

3. Outputs and Relationships

V-MUX System Designer™ 510 enables the user to define the operation of a vehicle network by assigning commands in the Relationship window 706 for output (see FIG. 7) unless an output has been defined as “True” or “Permanently On.”

In order to properly define the operation of a vehicle network, the user must determine the desired effect of an input or set of inputs. The user then selects the appropriate command(s) to accomplish the desired effect from the command database.

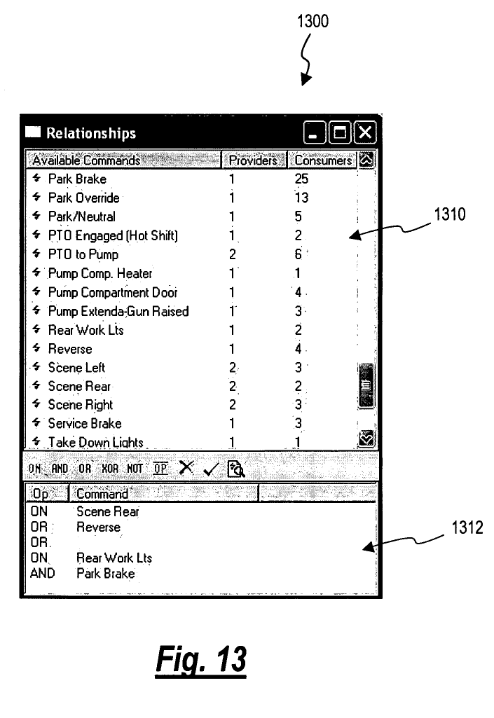

Referring now to FIG. 13, there is illustrated an example Relationships window 1300 of window 706. The user can move a command from the upper portion of the window 1310 to the lower assignment window 1312 in one of two ways. The user may click once on the command then once on the appropriate logical operand, or click and drag the command into the lower window wherein the operand box will prompt the user for a choice. The “ON” operand is assigned by default for the first command selected.

The logical “AND” operand is used when more than one condition must be met to turn on an output. For example, Water Temp High AND Park/Neutral requires that the water temperature to be above the high threshold and the vehicle must be in Park/Neutral for the command to be sent. The “OR” operand is used if an output is to turn “on” with either one of the two commands selected.

The logical “XOR” operand stands for “exclusive OR” and is used when one or the other command may be used to change the status of the output but not both. The XOR may conveniently be used for three-way switching when two different commands are used. For example, if a vehicle design requires a light to turn on or off from two locations, but the switches also serve two other functions, then it would be appropriate to use the XOR operand. To control a device from two locations with the same command, the user must set the three-way property to “True” in the Input properties for the inputs assigned to the command.

The logical NOT operand is used to set a condition based on an input being off instead of on. For example, NOT Park/Neutral would turn on an output when the transmission is not in park or neutral.

4. Adding a Vista Display Node

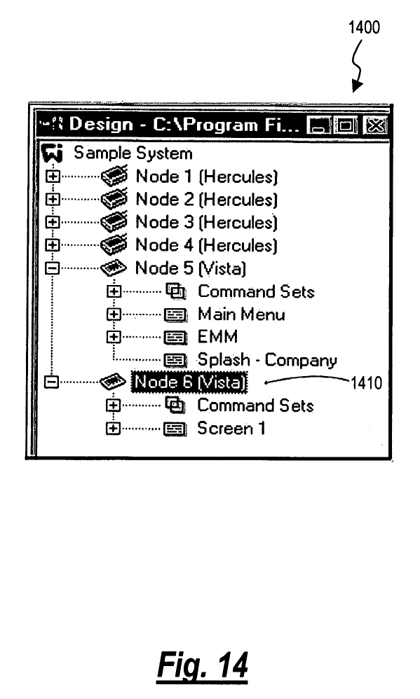

With reference to FIG. 14 in combination with FIG. 7, there is illustrated a sample Design Tree 1400 of window 704 having a Vista display node entry 1410 defined as node 6. A Vista display node may be added to a Design by selecting the Vista icon from the tool bar. By default, Command Sets and Screen 1 are added. As shown in FIG. 14, Node 5 (identified as 1412) has three screens and Node 6 has the default settings. Screens can be added to a Vista display node by clicking on the screen icon 726 on the tool bar (see FIG. 7). The screen icon 726 is ghosted out if the Vista has not been selected. Several of the icons on tool bar 701 are only selectable if the proper item is selected in the design tree that correlates with the icons on the tool bar.

5. Screen Properties

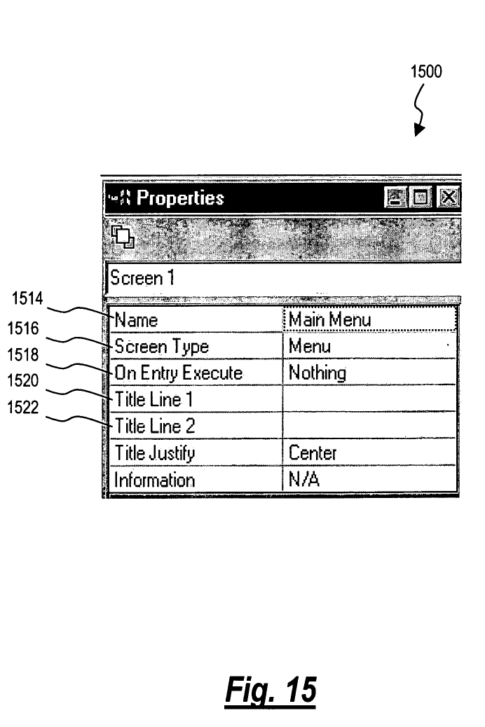

FIG. 15 illustrates the Properties window for screen 1 of Vista display node 6. Naming screens before setting the Vista properties will be more intuitive for most users. As shown, the Name property 1514 can be changed to, for example, “Main Menu.” The next property is the Screen Type 1516. There are three types of screens: Menu, Information and Diagnostics. The Menu screen is the most common screen. It allows for commands and titles to be assigned to each button, just like inputs. The Menu screen also allows for several analog data values to be shown with their names. The Information screen may be a pure text screen used for displaying vehicle information, creating “Splash” screens, or providing other useful text-based information. The Diagnostics screen is helpful in troubleshooting the V-MUX system and provides useful diagnostic information. Title Line 1, 1520, will use the default title assigned in the main Vista properties if it is left blank. Title Line 2, 1522, is displayed directly below the main title, and it may be used to name screens so that operators may easily navigate between menus and sub-menus.

6. Properties of the Vista Display Node

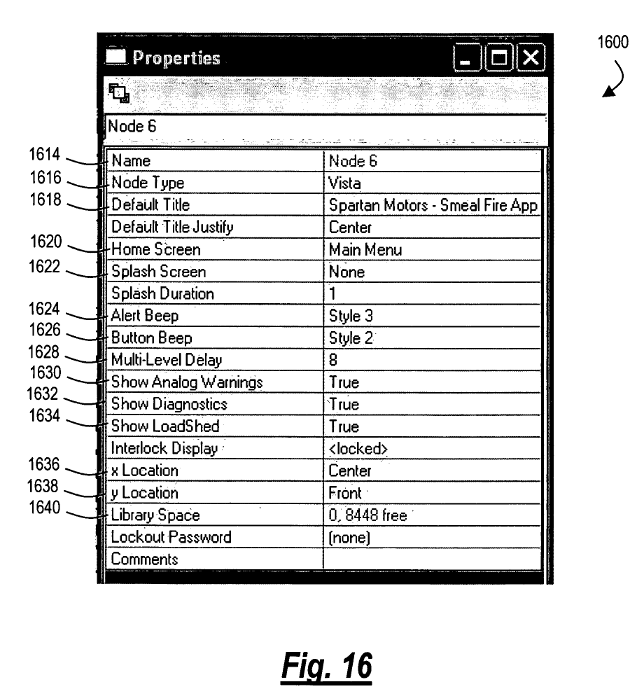

FIG. 16 depicts the properties window 1600 of Vista display node 400. The “Name” property 1614 of a Vista display node is automatically assigned by the system and cannot be changed by the user. The “Node Type” property 1616 is assigned when the user selects the Vista icon from the tool bar. This also cannot be changed by the user. The “Default Title” 1618 can be changed by the user, and may be up to 40 characters in length including spaces. The default title will show up in every screen that the user has not defined the Title Line 1 property. The “Home Screen” property 1620 identifies the screen to display at startup and when selecting the home button. The “Splash Screen” property 1622 enables the user to create a splash screen by adding a screen to the Vista and setting the screen property for that screen to “information.”

The “Alert Beep” property 1624 enables the user to select from several beep styles to alert the operator of a System Error Message. The “Button Beep” property 1626 enables the user to select from several styles of button beeps every time the operator presses a button, the Vista node will beep according to the selected style. The “Multi-Level Delay” property 1628 enables the user to select from ten levels of delays. This allows the user to delay sending a command when using PWM control. “Show Analog Warnings” 1630, “Show Diagnostics” 1632 and “Show Loadshed” 1634 properties are all True or False options. Set to true to display messages on the 14^{th} line of the Vista. “X location” 1636 and “Y location” 1638 are properties that reflect the general location of the node for a Layout report (not shown). “Library Space” 1640 indicates how much space is used and how much is free. The example shown indicates that 0 bytes are used and 10240 bytes are free.

7. Command Sets

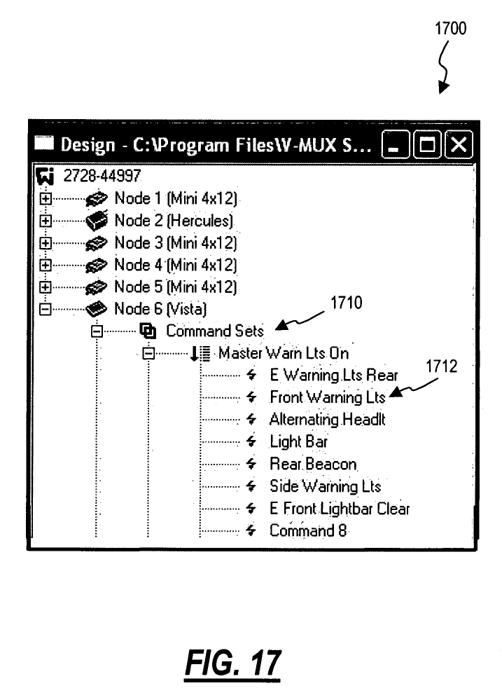

FIG. 17 illustrates an expanded Design Tree 1700 including the command sets 1710 of nodes. The V-MUX System Designer™ 510 enables a user to build sets of commands in each display and I/O node. The user may assign one or more command sets to the inputs or buttons of the associated display and I/O nodes. A command set may be used when it is necessary to send more than one command from an input or button. By default two command sets are included with a Vista display node, but this can be increased up to 16. There may be up to 20 commands to each command set.

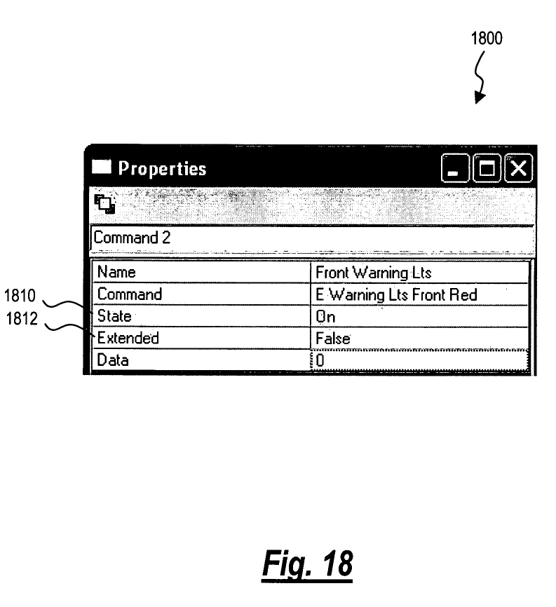

To preview or define the properties of a command in a command set, the user may select the command and right-click a mouse computer control or equivalent device. This will cause a list of command categories to be displayed, similar to the categories displayed during the assignment of inputs. Selecting the appropriate category and the command to be assigned causes the Properties window to be displayed. FIG. 18 illustrates the properties window 1800 for command 1712 shown in FIG. 17. In most cases, only a few commands will be used in each command set. The present example illustrates the implementation of an emergency master switch which allows the operator to press one button to cause the node to send out all the necessary commands to turn on all the emergency devices. In the past, operators may have used latch switches and left them in the latched position, then wired the emergency master switch to power all these other switches. The present invention accomplishes the same result without a need to hard-wire switches and wiring. One command set is defined for “On” and a second command set is defined for “Off.”

As shown in FIG. 18, the State property 1810 for the Strobe Front, Command 1, is set to “On.” This means that when this command set is executed the command “Strobe Front On” will be transmitted to the VEHICLE network 120 (see FIG. 1). The “Extended” property 1812 is set to “False.” This is a three-way property and would be set to “True” if the vehicle design required the status to be the reverse of the last time this command was sent. Command sets can also be assigned to a Vista Screen under the “On Entry Execute” property 1518 (see FIG. 15). One useful feature is the ability to assign a relationship to each command set. For example, by clicking on Command Set 1, the user is able to “drag” a command, such as with a mouse computer control, from the top half of the relationships window to the lower assignment half, just like an output of a node. The user should use this property to prevent commands from being re-executed for some reason.

8. Menu Screens and Button Properties

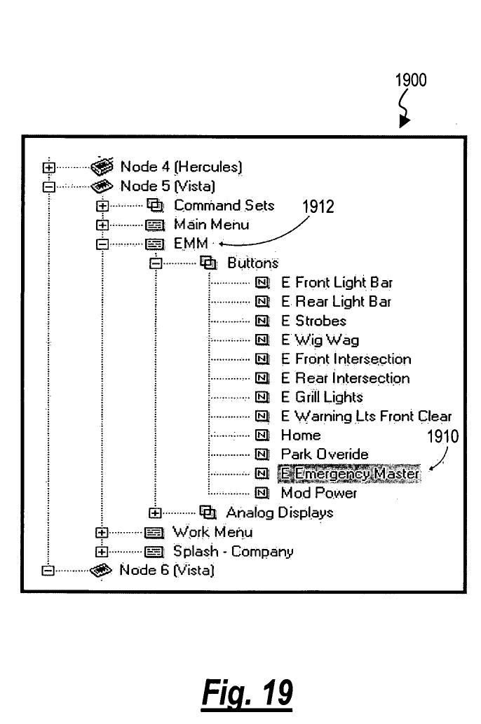

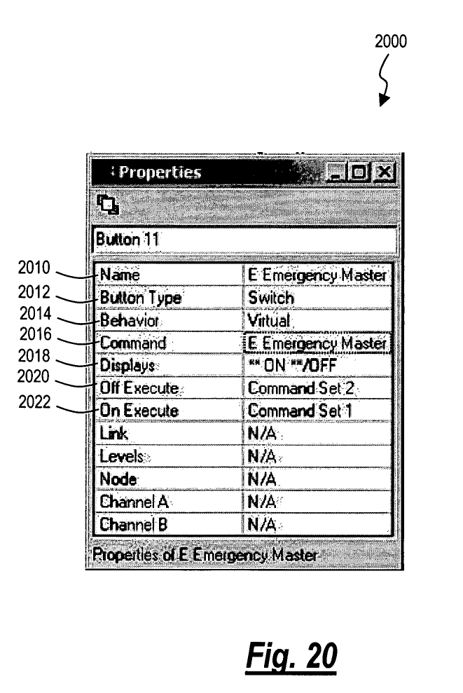

Referring now to FIGS. 19 and 20, there are illustrated an expanded portion 1900 of the Design Tree 709 (see FIG. 7) showing entries for Emergency Master button 1910 of the EMM Screen 1912 selected, and the associated Properties window for the emergency master button.

As shown in FIG. 4, there are 12 buttons on a Menu Screen. Buttons 1-4 (412-418) are at the left side of the screen, buttons 5-8 (420-426) are on the right and buttons 9-12 (428-434) are along the bottom. As shown in FIG. 19, all of the buttons for the EMM Screen 1912 have been assigned descriptive names. FIG. 20 illustrates the properties of button 11, the emergency master button 1910.

FIG. 20 illustrates a properties window 2000 for button 1910 of FIG. 19. The “Name” property 2010 is derived from the Command Property. There are three “Button Types” 2012 available: Switch, Screen Link and Multi-Level PWM. The “Behavior” property 2014 may be one of a set of values. The default value of “Virtual” will be appropriate in most cases. Using the Virtual behavior property will reflect when the command assigned to this button is used from other locations. The other behavior property is “Latched,” which means the legend assigned to this button (“On/Off”), can only be changed by this button. The “Command” property 2016 is used to assign a command to a button just like the inputs on an I/O node. The “Displays” property 2018 may be one of several variations of the On/Off. “Off Execute” 2020 and “On Execute” 2022 may be used to assign Command Sets to these two properties to send multiple commands across the system. In the present example, command set 1 is assigned to “On Execute” and Command Set 2 is assigned to “Off Execute.” V-MUX System Designer™ 510 allows the user to define multiple commands to be processed, for example, all the commands which may be turned on and off by pressing the Emergency Master button. Accordingly, a single button can cause up to 20 “On” commands to be sent over the data bus 118. Likewise, up to 20 “Off” commands may also be sent.

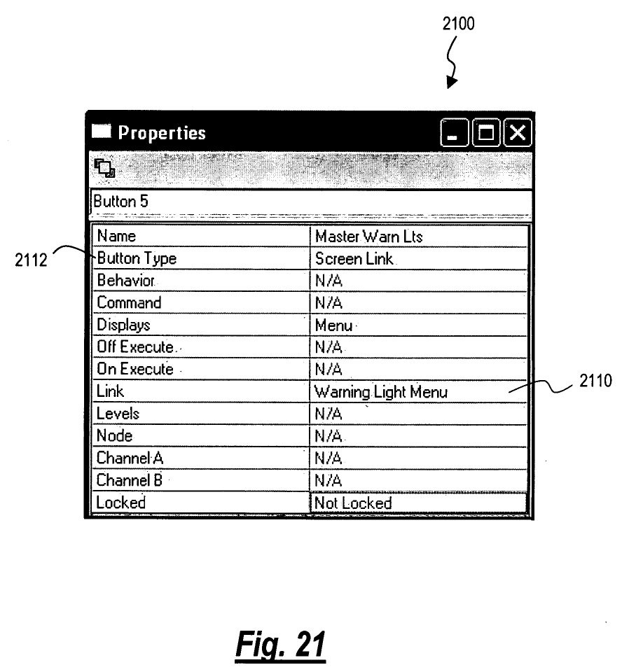

FIG. 21 depicts an alternate Properties window 2100 for Emergency Master button 1910. The “Button Type” property 2112 is “Screen Link.” This directs the display node to display a linked screen when the Emergency Master button is pressed. The “Link” property identifies the screen to which the button is linked. The user may select the screen from a drop-down list of defined screens 2110.

9. Multi-Level PWM Button Type

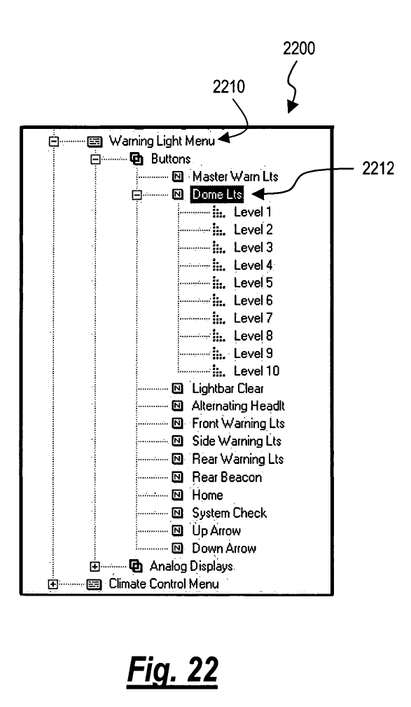

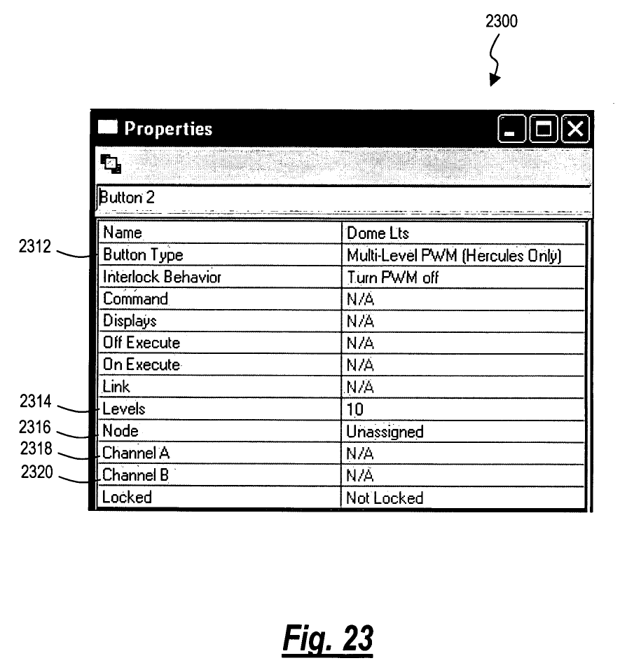

The Multi-Level PWM button enables a user to define a set function for a button feature. For example, a button can be programmed to act as an incremental dimmer. FIG. 22 shows a design tree 2200 including a work menu 2210 and a dome lights button 2212. As shown in FIG. 23, the “Button Type” property 2312 of properties screen 2300 is assigned “Multi-Level PWM,” causing many of the properties to be assigned “N/A.” The four lower properties, “Levels” 2314, “Node” 2316, “Channel A” 2318 and “Channel B” 2320 apply to multi-level PWM buttons, and can now be used. The “Levels” property 2314 allows the user to set the number of PWM levels assigned to the button. In FIG. 23, 10 levels have been selected. The Design Tree of FIG. 22 reflects the number of levels selected. The “Node” property 2316 identifies the node to use the channels on. The last two properties “Channel A” 2318 and “Channel B” 2320 allow the user to select from 1-4 the PWM channels controlled on the selected node. Logical Channels 1 and 2 are mapped to physical channels 1 and 2. Channels 3 and 4 are mapped physical channels 15 and 16 in an I/O node.

Once all the properties for the button have been set, the user may set any interlock for that button by dragging it down from the relationship “Available Commands” window to the relationship “Assignment” window, such as 1310 and 1312 respectively, shown for example in FIG. 13.

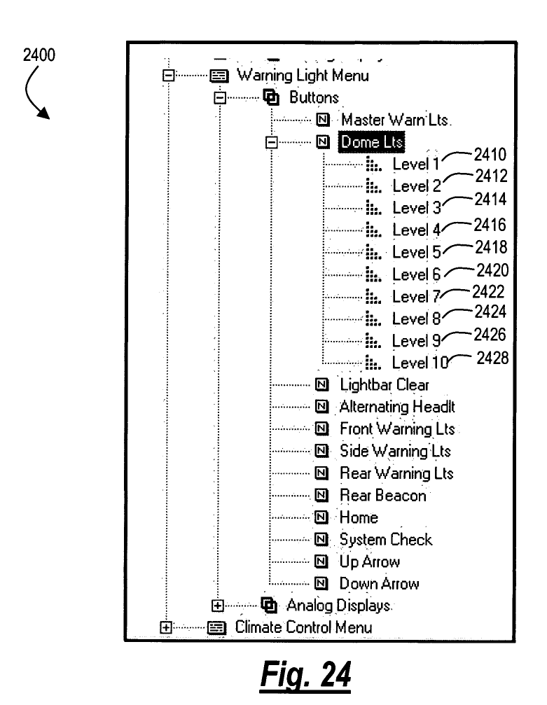

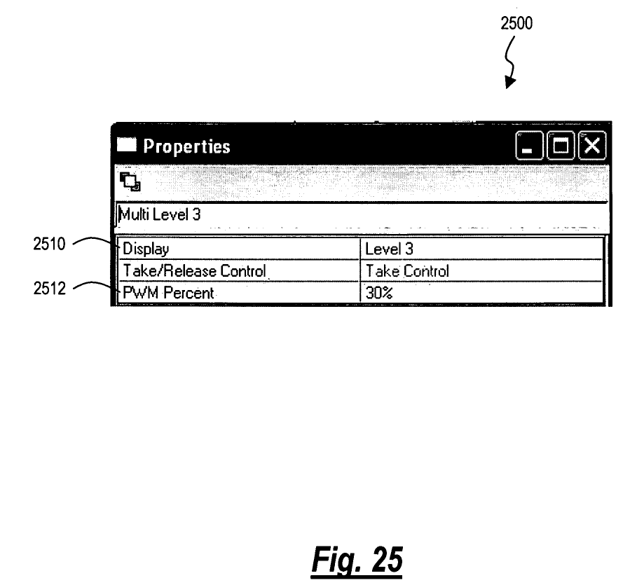

The properties 2410-2428 for each level may be set by the level as shown in design tree 2400 of FIG. 24, and filling in the properties of property screen 2500, shown in FIG. 25. The “Display” property 2510 may be assigned any text that makes sense. In most cases, the user should think in terms of levels, and assign, for example, “Level 1” or a word like “Low.” The “PWM Percent” property 2512 indicates the percentage of power supplied to the output for the button step. It is important to define at least one level that is “Off,” where desired. The PWM controls will control an output on any I/O node and will override any relationships other than the one assigned to the button. For example, if the “Side Door” has been assigned to turn on the dome lights at 50% duty cycle, the Multi-Level PWM control on a display node will take over until the control has been turned to “Off.”

10. V-MUX Downloader™

Referring again to FIGS. 1 and 5, in an embodiment of the present invention, V-MUX Downloader™ 512 requires the user to connect serial data bus wiring 118 between transceiver 112 and network 120 of vehicle 114. Electrical cable 116 must also be connected between PC 110 and transceiver 112. Once all connections are complete, a first indicator 122 will be illuminated when the electrical power is on.

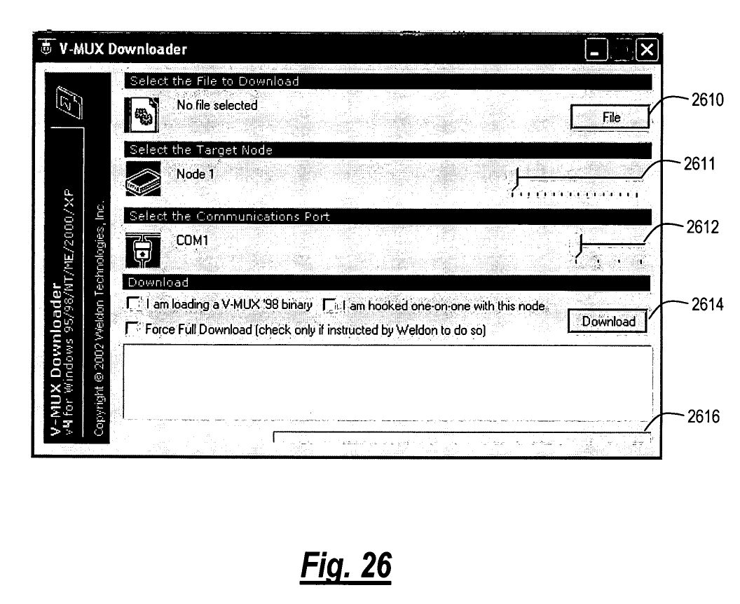

Referring now to FIG. 26 in combination with FIG. 1, to download a file the user selects the “File” button 2610; this allows the user to browse the computer to retrieve a stored binary file. The target I/O node 200 is selected by moving the slide bar 2611 to the desired node with the mouse control of PC 110. Next, the user selects the communications port of PC 110 to which the RS-232 serial connector is connected to. The user may simply slide bar 2612 from left to right. Typically COM1 will be used. Next the user must choose whether the node is blank or active. This can be determined by examining the end of the node when it is powered with 12 VDC. If first indicator 122 is flashing, then it is an active node. If first indicator 122 is illuminated but not flashing, then it is a blank node. Next the user may click the download button 2614 to begin downloading the data to the node. During the download, first indicator 122 should be illuminated without flashing (i.e., “on solid”), even if it was initially flashing. Also, a second indicator 124 next to indicator 122 should be illuminated but not flashing, indicating that the node is receiving data over its comm port. When the status bar 2616 indicates that the download is nearly complete, first indicator 122 is observed; it should pulse a few times to indicate the end of the download procedure. If indicator 122 does not pulse, the node may not have properly received all the data and the downloading procedure should be repeated.

C. Programmable Switching System

This section provides additional details relating to the programmable switching system discussed in the “Hardware Environment” section, above.

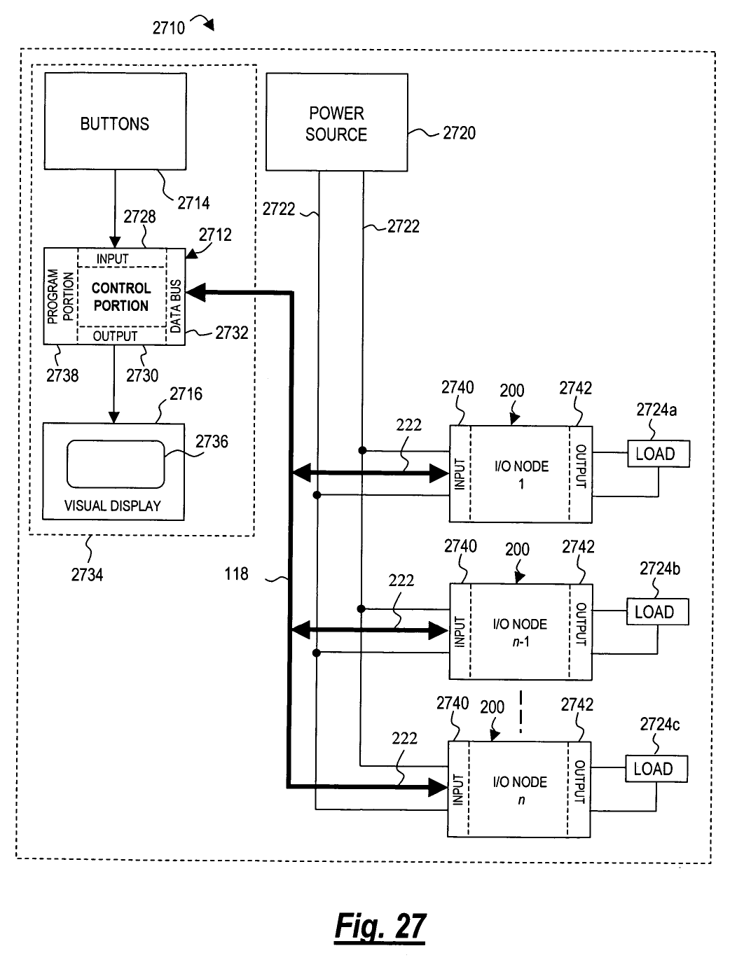

The general arrangement of a programmable switching system 2710 according to an embodiment of the present invention is shown in FIG. 27. One skilled in the art will recognize that programmable switching system 2710 is an alternate embodiment of vehicle network 120 (see FIG. 1). Programmable switching system 2710 comprises a display node 2734, which one skilled in the art will further recognize as an alternate embodiment of display node 400 (see FIG. 1). Programmable switching system 2710 further comprises at least one I/O node 200.

1. Display Node

Display node 2734 comprises a control portion 2712 electrically coupled to at least one button 2714 and a visual display 2716. Control portion 2712 is also electrically coupled to a data bus 118.

Control portion 2712 generally resembles I/O node 200 insofar as the CPU, memory, interface, and communications portions depicted in FIG. 2. As such, the discussion above relating to FIG. 2 is generally applicable to control portion 2712, with the exceptions noted below. Control portion 2712 may comprise a CPU such as computer, microprocessor, microcontroller or the like and includes input and output (“I/O”) portions 2728 and 2730 respectively. Control portion 2712 further includes a data bus port 2732 for electrical communication with peripheral devices via data bus 118. As shown in FIG. 27, buttons 2714 are electrically connected to input 2728 of control portion 2712. The buttons 2714 are adapted to transmit a digital electrical signal to input 2728 of control portion 2712 whenever a button is actuated. Output 2730 of control portion 2712 is electrically connected to visual display 2716, and is adapted to transmit display-related information from the control portion to the visual display. The display-related information may pertain to images to be shown on a display screen 2736. The display-related information may also pertain to display-control commands including, but not limited to, brightness-level settings for display screen 2736. The display-related information may be transmitted from control portion 2712 to visual display 2716 in any conventional analog or digital format, or any combination of analog and digital formats compatible with visual display 2716.

Control portion 2712 further includes a program portion 2738 adapted for receiving and storing a predetermined set of instructions to be executed by the control portion. The set of predetermined instructions may pertain to various functions of the system 2710, including definitions and parameters of images to be displayed on display screen 2736 (such as menus and sub-menus), definitions of the electrical functions and operating characteristics of buttons 2714 and I/O nodes 200, predetermined operating modes for system 2710 (i.e., daytime operation, nighttime operation, emergency operation, override of certain conditions and limits, etc.), grouping and categorizing of I/O nodes 200 according to predetermined functions and system operating modes, addresses for I/O nodes 200, and predetermined programmable switching system 2710 responses to user selections of buttons 2714. The instructions stored in program portion 2738 may be modified or replaced when desired by the user, allowing the user to change the appearance of images displayed on display screen 2736, and also change the functional states and operation of I/O nodes 200 in response to selections of buttons 2714. By way of example, if additional lights are installed on the vehicle in which the programmable switching system 2710 is installed, the instructions may be modified to add a selectable menu page image to visual display 2716, providing the user with choices regarding operation of the added lights. The modified instructions may include addressed actuation commands for any additional I/O nodes 200 that may be added to system 2710 to control the lights. As previously detailed, changes made to the instructions of program portion 2738 allow for a wide variety of program changes to programmable switching system 2710, such as changing the images displayed on screen 2736, changing associations between buttons 2714 and I/O nodes 200, defining groups of I/O nodes that may be associated with one or more buttons 2714, and reconfiguring the functional states of I/O nodes (i.e., dimming ranges, actuation delay times, maximum allowable current, thresholds and limits, cycling lights on and off for flashing, and so on.). One skilled in the art will recognize that the operation and functional characteristics of buttons 2714, visual display 2716 and I/O nodes 200 may be modified in numerous respects by appropriate changes in the instructions stored in program portion 2738.

At least one button 2714 is provided. Buttons 2714 may be any type of conventional electrical switch, such as a momentary single-pole single-throw (“SPST”) switch. Button 2714 may be adapted to transmit a digital signal, such as an “active-high” signal (i.e., logical “0” to logical “1” voltage transition) to input 2728 of control portion 2712. Alternatively, button 2714 may be adapted to transmit an “active-low” digital signal (i.e., logical “1” to logical “0” voltage transition). In one embodiment of the present invention, button 2714 may be a conventional “touch switch” affixed to or otherwise located proximate to display screen 2736 of visual display 2716.

Control portion 2712 may function with button 2714 such that the state of a load 2724 controlled by an I/O node 200 associated with the button is changed only when a predetermined time has elapsed after the button is actuated. This delay function is useful for staging the actuation and de-actuation of loads to prevent large or sudden changes in the current demand placed on electrical power source 2720. In other embodiments a delay may be used to sequence the actuation and deactuation of various loads, such as components of a system that must be turns on and off in a particular order.

Visual display 2716 may comprise any type of conventional visual information display screen 2736 available in the art. Examples include, but are not limited to, active matrix liquid crystal (“AMLCD”), Organic Light Emitting Diode (“OLED”), electroluminescent (“EL”), plasma, and cathode ray tube (“CRT”) displays. Visual display 2716 may be used to present alphanumeric and/or graphic visual information. Visual display 2716 is adapted to receive control data and/or image data, such as alphanumeric and/or graphical information from control portion 2712 and display the information on display screen 2736. The information received from control portion 2712 may be in any conventional analog or digital format (or any combination of analog and digital formats) available in the art, that are compatible with visual display 2716.

Visual display 2716 may comprise a conventional backlight (not shown) to illuminate display screen 2736 under varying ambient lighting conditions. Types of backlighting include, but are not limited to, electroluminescent lamps, light emitting diodes, fluorescent lamps, incandescent lamps and discharge lamps.

2. I/O Node

I/O node 200 comprises the elements previously discussed in detail (see FIG. 2). In FIG. 27, additional connections between a power source 2720 and I/O node 200 via electrical wiring 2722 are shown to more particularly describe the operation of programmable switching system 2710.

Input portion 2740 includes a serial data bus interface 222 and connections to an electrical power source 2720 via electrical power wiring 2722. Data bus interfaces 222, 224 of each I/O node 200 are in addressable communication with control portion 2712 via a data bus 118 such that each I/O node connected to the data bus has a predetermined address code. Each I/O node 200 responds only to commands from control portion 2712 that contain an address code corresponding to the predetermined address code for the I/O node. Likewise, each I/O node 200 may transmit data to control portion 2712 via data bus 118, such information including status information pertaining to I/O node 200 and/or load 2724 connected to the I/O node. Status information may comprise the actuation state of I/O node 200 and any faults present in the I/O node and/or load 2724.

An output portion 2742 of each I/O node 200 includes at least one digital output 220 (see FIG. 2) which is electrically connected to an associated load 2724, such as an emergency light. Output 220 is adapted to control the state of electrical power to load 2724 in accordance with the predetermined instructions of control portion 2712. I/O node 200 may be adapted to switch DC and/or AC voltages, and may use any conventional load-control circuitry such as, for example, electromechanical relays, solid-state relays, triacs, silicon controlled rectifiers (“SCRs”), transistors and field effect transistors (“FETs”). I/O node 200 may be adapted to function as an “On/Off” electrical power switch for an associated load 2724, and may further be adapted to provide a variable voltage or variable current to the associated load 2724. Variable voltage and/or current control may be effected by such means as analog voltage control, analog current control and pulse width modulation (“PWM”) circuitry.

I/O nodes 200 may be adapted with control portion 2712 such that various predetermined control categories are established. Control categories may be based on any conventional logical grouping, association or categorization. An example control category is grouping of lights for a particular function, such as exterior lights, so that a number of lights controlled by separate I/O nodes 200 may be actuated by a single command from control portion 2712. Similarly, various loads may be categorized by criticality such that higher-criticality loads have priority over those with lesser criticality if the power source 2720 is heavily loaded and load-shedding is required to prevent an electrical overload condition. One skilled in the art may conceive of various other types of control categories.

3. Data Bus

Electrical communication between display node 2734 and I/O node 200 is preferably by means of a data bus 118. Data bus 118 may be any conventional data bus, such as an RS45 serial data bus. Data bus 118 may utilize any conventional embodiment, such as wired, wireless, fiber optic, and so on.

4. Example Embodiment

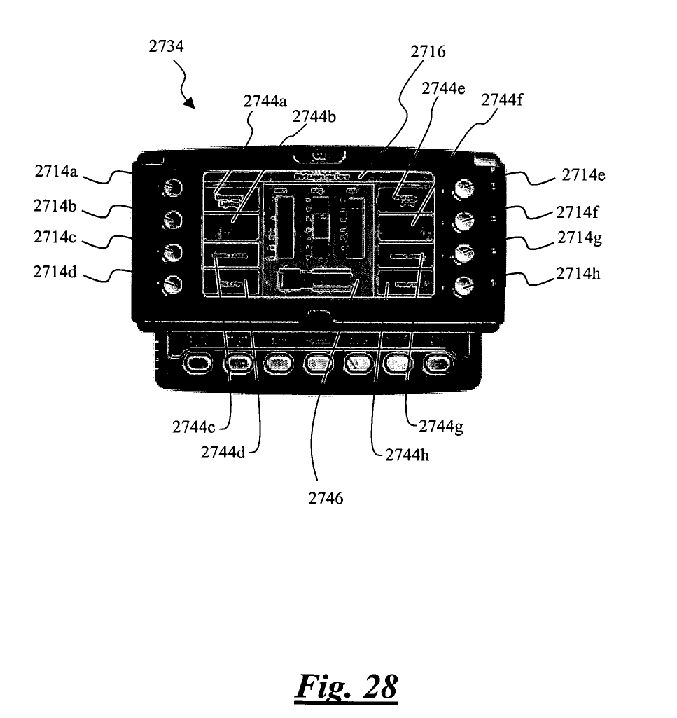

Referring now to FIG. 28 with continued reference to FIG. 27, a view of one embodiment of display node 2734 is shown. Display node 2734 comprises a plurality of buttons 2714a-2714h and a visual display 2716. Control portion 2712 may be located within display node 2734; however, one skilled in the art will recognize that the control portion may be located outside the display node in a remote location of the vehicle if desired, and connected to system elements 2714, 2716, 118 with appropriate electrical wiring. Visual display 2716 may be electronically divided into a plurality of fields for display of information and indicia, such as fields 2744a-2744h and 2746. Fields 2744a-2744h are associated with buttons 2714a-2714h respectively, the buttons being located generally adjacent to each associated field in this embodiment. At least one of a plurality of I/O nodes 200 (such as I/O nodes 1 to n in FIG. 27) may also be associated with at least one of the buttons 2714a-2714h. Fields 2744a-2744h may provide a variety of indicia and information pertaining to the I/O nodes 200 associated with buttons 2714a-2714h. For example, fields 2744a-2744h may display nomenclatures for each button 2714a-2714h, the nomenclatures being defined as a name, description or term that is representative of the loads 2724 associated with the buttons. In the example embodiment shown in FIG. 28, button 2714a controls “Emergency Lighting” for the vehicle, as depicted by field 2744a. Field 2746 may be used to display status indicia and information for system 2710, such as displaying a schematic presentation depicting the actuation status of various exterior lights on an emergency vehicle. Likewise, fields 2744a-2744h may be used to display status indicia, such as changing the color and/or text of the nomenclatures as well as changing the color of the fields.

Each I/O node 200 is associated with at least one button 2714a-2714h in a predetermined manner by program portion 2738, as previously detailed above. In operation, an operator may select any of buttons 2714a-2714h by depressing the button. The selected button transmits a digital signal to input 2728 of control portion 2712, the digital signal representing the particular button. Control portion 2712 responds to the digital signal in accordance with the instructions stored in program portion 2738 for the selected button 2714 and the associated field 2744. Example responses may include changing in a predetermined manner the image shown on screen 2736, such as changing the nomenclature and/or color of the associated field to indicate the status of the associated load (i.e., ON, OFF, DIM, etc.), and transmitting a predetermined addressed command to at least one I/O node 200 associated with the button to change the electrical status of the load 2724 connected to the associated switch. The change in status may be to begin supplying electrical power to the load, stop supplying power to the load, or to begin supplying a changed value of voltage or current to the load.

In one embodiment of the present invention, buttons 2714 may be used to access images on screen 2736 showing at least one menu and/or submenu screen. For each menu and/or submenu screen or “page” the fields 2744a-2744h, 2746 may contain differing choices and/or information regarding various I/O nodes 200 and/or combinations or groups of I/O nodes. Thus, a common set of buttons 2714 may be used in association with differing I/O nodes 200 or combinations or groups of I/O nodes, depending upon the particular menu or submenu screen being displayed and the functions defined in accordance with the predetermined instructions stored in program portion 2738 of control portion 2728.

Further, the I/O nodes 200 may function differently, depending upon the menu page displayed and the functional definitions for button 2714 and associated I/O nodes for the particular menu page being displayed. For example, I/O node 200 (labeled “I/O Node 1” in FIG. 27) may be configured as an “On/Off” switch for a load 2724a, such as a lamp, on a first menu page. On a second menu page, I/O node 1 may be configured as a PWM-controlled switch to dim the lamp. One skilled in the art will easily recognize that the architecture of the present invention allows for expansion of system 2710 and/or tailoring of the operation of the system to satisfy new requirements or changing needs. As such, the buttons 2714 may be termed programmable or “virtual” switches, since the functions of the switches are not fixed and instead are defined by the instructions stored in program portion 2738.

5. System Architecture

As one skilled in the art will realize from the foregoing discussion, there is no fixed, physical or otherwise “hard-wired” relationship between display node 2734 and I/O nodes 200. Actuation by an operator of one or more buttons 2714a-2714h (see FIG. 28) will result in a response by system 2710 that is in accordance with the instructions and relationships established by the user and stored as a program in program portion 2738. When an operator actuates a particular button 2714a-2714h, the control portion 2712 receives and electrical input signal corresponding to the button. Control portion 2712 compares the particular input signal to a corresponding portion of the program stored on program portion 2738. “Portions” may be logical program segments represented on visual display 2736 as “pages” or “menus.” Control portion 2712 may then actuate one or more I/O nodes 200 in accordance with the program instructions corresponding to the actuated button 2714.

The relationships and interactions between control portion 2712, buttons 2714, visual display 2734, and I/O nodes 200 are defined by the user, as detailed above, and stored in program portion 2738. As such, the relationships and interactions between control portion 2712, buttons 2714, visual display 2734, and I/O nodes 200 may be augmented, changed and removed as the needs of the operators of the vehicle change.

While this invention has been shown and described with respect to a detailed embodiment thereof, it will be understood by those skilled in the art that various changes in form and detail thereof may be made without departing from the scope of the claims of the invention.

What is claimed is:

1. A programmable switching system, comprising:
a) at least one I/O node;
b) at least one button;
c) a visual display;
d) a control portion in electrical communication with the at least one I/O node, the at least one button and the visual display, the control portion being responsive to a set of predetermined instructions and being adapted to:
i) provide information to the visual display for displaying the nomenclature of the at least one I/O node,
ii) monitor the at least one button for actuation,
iii) control the state of the at least one I/O node in a predetermined manner when the at least one button is actuated, and
iv) provide information to the visual display for display of indicia corresponding to the status of the at least one I/O node, wherein the at least one I/O node, the at least one button and the visual display are logically associated with one another by the predetermined instructions, the predetermined instructions being programmable to modify the logical association of at least one of the at least one I/O node, the at least one button, and the visual display.

2. The programmable switching system of claim 1 wherein the status information is provided by at least one of a nomenclature and a predetermined color.

3. The programmable switching system of claim 1, wherein the at least one I/O node communicates status information to the control portion, and wherein the control portion monitors and displays the status information on the visual display.

4. The programmable switching system of claim 3, wherein the status information relates to the actuation state of the at least one I/O node.

5. The programmable switching system of claim 3, wherein the status information relates to a fault condition.

6. The programmable switching system of claim 5, wherein the fault condition is one of over-voltage, over-current, an open circuit and a short circuit.

7. The programmable switching system of claim 5 wherein the fault condition relates to a fault in the at least one I/O node.

8. The programmable switching system of claim 5 wherein the fault condition relates to a fault in an electrical load connected to the at least one I/O node.

9. The programmable switching system of claim 1 wherein the electrical communication comprises a data bus.

10. The programmable switching system of claim 1 wherein the visual display comprises a liquid crystal display screen.

11. The programmable switching system of claim 1 wherein the visual display comprises an organic light emitting diode display screen.

12. The programmable switching system of claim 1 wherein the visual display further comprises a backlight.

13. The programmable switching system of claim 1 wherein the at least one button comprises a touch switch integrated with the visual display.

14. The programmable switching system of claim 1 wherein the at least one I/O node comprises an electromechanical relay.

15. The programmable switching system of claim 1 wherein the at least one I/O node comprises a field effect transistor.

16. The programmable switching system of claim 1 wherein the at least one I/O node comprises a solid state relay.

17. The programmable switching system of claim 16 wherein the solid state relay is adapted to control alternating-current voltages.

18. The programmable switching system of claim 16 wherein the solid state relay is adapted to control direct-current voltages.

19. The programmable switching system of claim 1 wherein the at least one I/O node comprises a variable voltage control circuit, and wherein the at least one I/O node is responsive to a plurality of button actuations to change the amount of voltage provided to an electrical load by the I/O node.

20. The programmable switching system of claim 19 wherein the variable voltage control circuit comprises pulse width modulation circuitry.

21. The programmable switching system of claim 1 wherein the at least one I/O node comprises a variable current control circuit, and wherein the at least one I/O node is responsive to a plurality of button actuations to change the amount of current provided to an electrical load by the I/O node.

22. The programmable switching system of claim 21 wherein the variable current control circuit comprises pulse width modulation circuitry.

23. The programmable switching system of claim 1 wherein the control circuit changes the state of the at least one I/O node a predetermined period of time after the at least one button is actuated.

24. The programmable switching system of claim 1 wherein the visual display further comprises a plurality of selectable menu screens.

25. The programmable switching system of claim 1 wherein the control portion is reconfigurable to change at least one of the nomenclature and the indicia displayed on the visual display.

26. The programmable switching system of claim 1 wherein the control portion is reconfigurable to change the functional states of the at least one I/O node.

27. The programmable switching system of claim 26 wherein the control portion further comprises at least one predetermined control category for the at least one I/O node.

28. A programmable switching system, comprising:
a) a plurality of I/O nodes;
b) a plurality of buttons;
c) a visual display;
d) a control portion in electrical communication with the I/O nodes, the buttons and the visual display, the control portion being responsive to a set of predetermined instructions and being adapted to:
i) provide information to the visual display for displaying the nomenclatures of the I/O nodes,
ii) monitor the buttons for actuation,
iii) control the state of at least one I/O node in a predetermined manner when a button is actuated; and
iv) provide information to the visual display for display of indicia corresponding to the status of the I/O nodes, wherein the I/O nodes, buttons and visual display are logically associated with one another by the predetermined instructions, the predetermined instructions being programmable to modify the logical association of at least one of the I/O nodes, buttons and visual displays, and wherein the control portion communicates with the I/O nodes by means of a common electrical connection, the I/O nodes being individually addressable by the control portion to control the state of the I/O nodes.
